(19) United States
(12) Patent Application Publication
(10) Pub. No.: US 2023/0101514 A1
(43) Pub. Date: Mar. 30, 2023

(54) PLATFORM PROVIDING CATERED SELECTION OF EVENTS AND REAL-TIME EVENT INFORMATION

(71) Applicant: Make Your Life Entertaining, Inc., Columbus, OH (US)

(72) Inventors: Kevin Lloyd, Columbus, OH (US); Sherry Bean-Lloyd, Columbus, OH (US)

(73) Assignee: Make Your Life Entertaining, Inc., Columbus, OH (US)

(21) Appl. No.: 17/956,973

(22) Filed: Sep. 30, 2022

Related U.S. Application Data
(60) Provisional application No. 63/250,589, filed on Sep. 30, 2021.

(51) Int. Cl. G06Q 30/02; G06Q 10/02; G06Q 50/00

(52) U.S. Cl. CPC G06Q 30/0282; G06Q 10/02; G06Q 50/01

(57) ABSTRACT

The present invention provides a platform providing curated entertainment options and event suggestions based on preference data associated with a user profile and/or feedback provided regarding the entertainment options and event suggestions. The platform is configured to receive feedback regarding pandemic compliance measures (e.g., COVID-19 safety protocols) and/or disability accommodations provided by the one or more venues and/or events. The platform includes an artificial intelligence module, which analyzes the feedback regarding pandemic compliance measures and/or disability accommodations in order to generate custom-catered suggestions for each user profile.

### CROSS REFERENCE TO OTHER APPLICATIONS

This application is related to and claims priority from the following U.S. patents and patent applications. This application claims priority to and the benefit of U.S. Provisional Application No. 63/250,589, filed Sep. 30, 2021, which is incorporated herein by reference in its entirety.

### BACKGROUND OF THE INVENTION

### 1. Field of the Invention

The present invention relates to platforms for creating events and generating a curated selection of events and/or activities, and more specifically to platforms providing analytics and feedback capability for event and/or venue compliance with health and safety measures.

### 2. Description of the Prior Art

It is generally known in the prior art to provide platforms for visualizing the location of events and/or venues on a map. Furthermore, it is generally known to provide platforms for the creation of events and providing messaging and alerts related to created events.

Prior art patent documents include the following:

U.S. Pat. No. 8,700,540 for Social event recommendations by inventors Zambrano et al., filed Nov. 29, 2010 and issued Apr. 15, 2014, discloses a method including accessing a plurality of event listings, accessing event information associated with the event listings, accessing social network information associated with a particular user, and ranking the event listings for the particular user based at least in part on the social network information and event information.

US Patent Publication No. 2010/0325205 for Event recommendation service by inventors Murphy et al., filed Jun. 17, 2009 and published Dec. 23, 2010, discloses an event recommendation service. In embodiments, selection data that correlates to media content selected by a user, location data that corresponds to a location of the user, and event data is received. A recommendation for an event that the user is likely to attend and that is proximate the location of the user can be generated by aggregating the selection data, the location data, and the event data. The recommendation can then be communicated to a user device as a calendar entry, an email message, a text message, and/or an html page for display to inform the user of the event.

US Patent Publication No. 2019/0102687 for Event Recommendation System by inventors Terra et al., filed Mar. 22, 2018 and published Apr. 4, 2019, discloses an event recommendation system recommending events for a candidate attendee. The system recommends an event based on characteristics of the candidate attendee and characteristics of prior attendees that attended a prior occurrence of the event. A prior attendee may have a positive or negative experience with the prior occurrence of the event. A positive experience may be defined, for example, as enjoying the event, completing the event, or performing well in the event. A negative experience may be defined, for example, as not enjoying the event, not completing the event, or not performing well in the event. An event is recommended to a candidate attendee if the candidate attendee has similar characteristics to a prior attendee that had a positive experience. An event is not recommended to a candidate attendee if the candidate attendee has similar characteristics as a prior attendee that had a negative experience.

U.S. Pat. No. 11,010,677 for Event management system by inventors Terra et al., filed Mar. 22, 2018 and issued May 18, 2021, discloses an event management system generates and displays an event schedule for an attendee. An initial order of the event schedule is based on (a) events already completed by the attendee, (b) events to be completed by the attendee to meet an event completion target, and (c) a set of ordering rules associated with the set of events to be completed by the attendee. The event management system may include an interface for modifying the event schedule in accordance with the set of ordering rules. The interface may include an initial set of events, in an initial order with respect to a timeline. The event management system may receive user input including a proposed modification to the initial order of the events. The event management system may or may not permit the proposed modification based on the set of ordering rules.

US Patent Publication No. 2013/0227011 for Interest-Based Social Recommendations for Event Ticket Network Systems by inventors Sharma et al., filed Feb. 29, 2012 and published Aug. 29, 2013, discloses a method including accessing a graph structure comprising a plurality of nodes and edges connecting the nodes, determining a similarity score for each node with respect to a first node, ranking each of the nodes based on their respective similarity score, selecting a set of nodes based on the ranking of each node, and identifying one or more event associated with the selected set of nodes.

US Patent Publication No. 2016/0275183 for Event recommendation system and method by inventors Bufe et al., filed Sep. 18, 2015 and published Sep. 22, 2016, discloses a method, computer program product, and computer system for identifying data associated with an event. A recommendation is provided to at least the event based upon, at least in part, at least one of a character of the event determined based upon, at least in part, the data associated with the event, and a personality of a real-time crowd at the event determined based upon, at least in part, the data associated with the event.

US Patent Publication No. 2016/0275170 for Event recommendation system and method by inventors Bufe et al., filed Mar. 20, 2015 and published Sep. 22, 2016, discloses a method, computer program product, and computer system for identifying data associated with an event. A recommendation is provided to at least the event based upon, at least in part, at least one of a character of the event determined based upon, at least in part, the data associated with the event, and a personality of a real-time crowd at the event determined based upon, at least in part, the data associated with the event.

US Patent Publication No. 2020/0143273 for Intelligent recommendation of convenient event opportunities by inventors Bettencourt-Silva et al., filed Nov. 5, 2018 and published May 7, 2020, discloses embodiments for implementing intelligent recommendations of convenient event opportunities by a processor. A group of entities may be identified for one or more event opportunities or the one or more event opportunities may be identified for the group of entities according to one or more entity selection criteria and one or more event criteria. The one or more event opportunities and the group of entities may be matched according to a level of convenience for attending the one or more event opportunities of the group of entities. The one or more matching event opportunities may be ranked and suggested to the group of entities.

US Patent Publication No. 2015/0019642 for Calendar-event recommendation system by inventors Wang et al., filed Jul. 9, 2014 and published Jan. 15, 2015, discloses a calendar-event recommendation system that generates and displays event recommendations tailored to a user. The system may recommend events based on a user's current location. The system may recommend events based on a user's social network, such as if the user's friends attend an event, or an event organized by or affiliated with a person, place, or organization the user has interest in. The system may recommend events based on receiving an invitation from others, or if the user's contacts are in the event's guest list. The system may recommend events based on the user's past behavior, such as attending similar events. The system may recommend events based on a user's subscription to categories of certain types of events. After recommending an event, the system may automatically add the event to the user's calendar, add the user's name to a guest list, and share the event with the user's contacts.

US Patent Publication No. 2017/0034108 for Determining event recommendability in online social networks by inventors Fechete et al., filed Jul. 30, 2015 and published Feb. 2, 2017, discloses a method including, by a computing device, identifying an event in an online social network to be evaluated for recommendation to a user of the online social network and determining whether the event is recommendable to the user, the determination being based on identifying correlations between one or more characteristics of the user and a plurality of signals associated with the event. The method further includes, in response to determining that the event is recommendable, presenting a recommendation or promotion for the event to the user, and, in response to determining that the event is not recommendable, converting the event in accordance with the determining that the event is not recommendable. The signals may include content associated with the event, metadata associated with the event, or responses to a notification about the event by users of the online social network.

U.S. Pat. No. 10,002,194 for Event location with social network integration by inventor Russell, filed Dec. 21, 2012 and issued Jun. 19, 2018, discloses an event location system identifying events of interest to a user. The system uses a filter and location associated with the user to search a database of events, thereby producing an event result set representing current events near the user's location that match the user's filter. The filter may include one or more criteria, such as criteria obtained from one or more social networking profiles of the user. The location may be identified automatically, such as by using a Global Positioning System (GPS) module. The system may automatically update the event result set over time and as the user's location changes so that the event result set is always up-to-date and reflects the user's current location.

US Patent Publication No. 2013/0060744 for Personalized Event Search Experience using Social data by inventors Roychoudhuri et al., filed Sep. 7, 2011 and published Mar. 7, 2013, discloses a search engine receiving a query regarding a social event. The search engine may obtain static data that indicates a ranking of the event based on overall popularity and may change the ranking based on social data that is particular to the user issuing the query. The search results may be ordered by the ranking and returned together with other social data to a search component such as a Web browser. The Web browser may then display the results together with the other social data. The Web browser may receive additional input from the user regarding preferences and may provide the input to a backend system for use to satisfy subsequent social event queries.

U.S. Pat. No. 10,402,426 for Generating event suggestions for users from social information by inventors Baldwin et al., filed Sep. 26, 2012 and issued Sep. 3, 2019, discloses a social networking system suggesting events for a target user based on stored data in the social networking system related to the target user and to events. The social networking system may suggest events based on the target user's affinity for, connections with, or interactions with objects in the social networking system connected to or otherwise associated with the events. For example, an event is suggested to a target user if users connected to the target user already accepted an invitation to the event. As another example, an event organized by a particular entity is suggested to the target user because of interactions between the target user and other content provided by the entity. Invitations to suggested events may be presented to the target user via a client device, allowing the target user to easily join a suggested event.

U.S. Pat. No. 11,127,032 for Optimizing and predicting campaign attributes by inventors Thimmaiah et al., filed Nov. 19, 2018 and issued Sep. 21, 2021, discloses automatically optimizing sponsored content campaigns for a sponsored content provider for a particular consumption category across different content publisher networks. For example, performance data for sponsored content campaigns can be used to train a model for a consumption category to determine allocation scores that quantify a relationship between target audiences and the consumption category. In response to a content placement request to initiate a sponsored content campaign associated with the consumption category, allocation scores can be determined and used to dynamically determine an allocation of resources to appropriate audiences or segments based at least in part upon the trained optimization model. A campaign template can be generated that includes the target audience(s), sponsored content, and respective budget allocation, and any other information for the campaign. The campaign can proceed based at least in part on the campaign template, and performance of the campaign can be monitored and analyzed during the campaign to optimize the campaign dynamically.

US Patent Publication No. 2015/0248651 for Social networking event planning by inventors Akutagawa et al., filed Feb. 25, 2015 and published Sep. 3, 2015, discloses event planning using social networking enabling an efficient implementation of planning an event, as well as minimizing network traffic and optimizing other technological aspects of life. Additional information acquired by sensors and other technology is able to improve the quality of the event planning. Social network information as well as the additional information is able to be used to select aspects of the event such as time, location, and/or many other aspects of the event.

U.S. Pat. No. 10,251,021 for Venue and event recommendations for a user of a portable media player device by inventors Feldman et al., filed Sep. 21, 2015 and issued Apr. 2, 2019, discloses a method and system for generating by a server, a recommendation for a venue or an event of interest proximally located to an inferred current location of a user of a portable media player device. In an embodiment, a server may determine one or more media preferences for a user based at least in part on media stored on or accessed using the portable media player device of the user. The server may generate information related to the current location or a recommendation for a venue or an event of interest to the user based at least in part on the one or more media preferences and the inferred current location of the user. Once generated, the server then may communicate the recommendation (or the information) to the user, e.g. the portable media player device.

U.S. Pat. No. 10,959,040 for Venue and event recommendations for a user of a portable media player device by inventors Feldman et al., filed Feb. 13, 2019 and issued Mar. 23, 2021, discloses a method and system for generating by a server, a recommendation for a venue or an event of interest proximally located to an inferred current location of a user of a portable media player device. In an embodiment, a server may determine one or more media preferences for a user based at least in part on media stored on or accessed using the portable media player device of the user. The server may generate information related to the current location or a recommendation for a venue or an event of interest to the user based at least in part on the one or more media preferences and the inferred current location of the user. Once generated, the server then may communicate the recommendation (or the information) to the user, e.g. the portable media player device.

U.S. Pat. No. 9,141,960 for Venue and event recommendations for a user of a portable media player device by inventors Feldman et al., filed Jun. 23, 2008 and issued Sep. 22, 2015, discloses a method and system for generating by a server, a recommendation for a venue or an event of interest proximally located to an inferred current location of a user of a portable media player devise. In an embodiment, a server may determine one or more media preferences for a user based at least in part on media stored on or accessed using the portable media player devise of the user. The server may generate information related to the current location or a recommendation for a venue or an event of interest to the user based at least in part on the one or more media preferences and the inferred current location of the user. Once generated, the server then may communicate the recommendation (or the information) to the user, e.g. the portable media player devise.

US Patent Publication No. 2007/0265905 for Agent for discovering relevant content by inventor Lazier, filed May 10, 2006 and published Nov. 15, 2007, discloses systems and methods for identifying content relating to a user's interest. A user profile containing criteria for identifying content of interest to the user is generated. Items of relevant content are identified using the user profile and are published to the user through a user interface. The items are monitored, and the user is notified of changes to the items.

U.S. Pat. No. 9,660,971 for Generating event recommendations based upon media consumption by inventors Latin-Stoermer et al., filed Mar. 8, 2012 and issued May 23, 2017, discloses various embodiments for generating event recommendations. Embodiments of the disclosure obtain media consumption events corresponding to media consumption in a media player user interface. A pattern of media consumption for the user is identified. An artist recommendation is generated based upon the media consumption. An event recommendation is generated corresponding to the artist.

U.S. Pat. No. 10,719,838 for Generating event recommendations based upon media consumption by inventors Latin-Stoermer et al., filed Apr. 7, 2017 and issued Jul. 21, 2020, discloses various embodiments for generating event recommendations. Embodiments of the disclosure identify an event associated with a location and an artist. An artist recommendation corresponding to the artist is generated for users based upon the media consumption of the users. An event recommendation corresponding to the event is generated for users near the location. A level of demand for the event is determined based upon a conversion rate.

### SUMMARY OF THE INVENTION

The present invention relates to platforms for creating events and generating a curated selection of events and/or locations, and more specifically to platforms providing analytics and feedback capability for compliance with health and safety measures for events and/or venues.

It is an object of this invention to provide users with increased awareness and feedback capabilities regarding compliance with health & safety measures (e.g., COVID-19 safety compliance) and/or other accommodations (e.g., disability accommodations) at different venues and events.

In one embodiment, the present invention is directed to a server platform configured to receive feedback regarding health & safety measures and/or accommodations for one or more venues and/or events.

In another embodiment, the present invention is directed to a server platform including an artificial intelligence module configured to automatically generate recommendations for events and/or venues based on health and safety measures and/or accommodations provided by the events and/or the venues.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates an entertainment preference selection graphical user interface (GUI) according to one embodiment of the present invention.

FIG. 2 illustrates an event preference selection GUI according to one embodiment of the present invention.

FIG. 3 illustrates a notification settings GUI according to one embodiment of the present invention.

FIG. 4 illustrates an event creation GUI according to one embodiment of the present invention.

FIG. 5 illustrates an event creation GUI according to one embodiment of the present invention.

FIG. 6 illustrates a recurring event creation GUI according to one embodiment of the present invention.

FIG. 7 illustrates an event creation GUI with pandemic-related indicators according to one embodiment of the present invention.

FIG. 8 illustrates an event creation GUI according to one embodiment of the present invention.

FIG. 9 illustrates an event creation GUI with ticketing features according to one embodiment of the present invention.

FIG. 10A illustrates a venue and/or event suggestion GUI according to one embodiment of the present invention.

FIG. 10B illustrates a geographic filter for a venue and/or event suggestion GUI according to one embodiment of the present invention.

FIG. 10C illustrates a time-based filter for a venue and/or event suggestion GUI according to one embodiment of the present invention.

FIG. 10D illustrates a filter for a venue and/or event suggestion GUI according to one embodiment of the present invention.

FIG. 11 illustrates an event amplification GUI according to one embodiment of the present invention.

FIG. 12 illustrates a venue and/or event map GUI according to one embodiment of the present invention.

FIG. 13A illustrates a venue and/or event detail GUI according to one embodiment of the present invention.

FIG. 13B illustrates a venue and/or event detail GUI according to one embodiment of the present invention.

FIG. 13C illustrates a venue and/or event detail GUI according to one embodiment of the present invention.

FIG. 13D illustrates a venue and/or event detail GUI having integrated travel features according to one embodiment of the present invention.

FIG. 14 illustrates an event reminder creation GUI according to one embodiment of the present invention.

FIG. 15 illustrates an event management GUI for events a user plans to attend according to one embodiment of the present invention.

FIG. 16A illustrates a message history GUI according to one embodiment of the present invention.

FIG. 16B illustrates an activity history GUI according to one embodiment of the present invention.

FIG. 16C illustrate a notification history GUI according to one embodiment of the present invention.

FIG. 17 illustrates an advertisement creation GUI according to one embodiment of the present invention.

FIG. 18 is a schematic diagram of a system of the present invention.

### DETAILED DESCRIPTION

The present invention is generally directed to platforms providing for the creation of events and the generation of a curated selection of events and/or locations, and more specifically to platforms providing analytics and feedback capability for compliance with health and safety measures for events and/or locations.

In one embodiment, the present invention is directed to a server platform configured to receive feedback regarding health & safety measures and/or accommodations for one or more venues and/or events.

In another embodiment, the present invention is directed to a server platform including an artificial intelligence module configured to automatically generate recommendations for events and/or venues based on health and safety measures and/or accommodations provided by the events and/or the venues.

More options for entertainment exist in the US than ever before, and restaurants, activities, and venues are becoming more available to consumers than ever. While the Internet has provided for the discovery of more different restaurants and events than ever before, it is difficult to discover venues and activities of particular interest to a consumer due to the large number of options. Additionally, often one activity is scheduled, and other ancillary activities or services are needed to complete an entertainment experience. For example, individuals have tickets to a concert, and there is a need for determining a nearby restaurant to obtain food and/or beverages from, as well as a need to obtain a ride to the restaurant from the concert venue, or from the restaurant to the concert venue. Personal preferences for activities, restaurants, and types of entertainment are not currently accounted for when planning for an outing. Additionally, as people begin to go to sit-in restaurants and other social events with the COVID-19 pandemic still ongoing, many are concerned about COVID-19 safety protocol compliance at the event and/or venue or poor compliance by other attendees of the event that could put them at risk. Furthermore, more Americans than ever have special needs or desire special accommodations at venues, such as disability access, dog friendly areas, outdoor dining, alcohol service, vape friendly areas, vegetarian/vegan options, options for certain food allergies, etc. Therefore, an application is needed wherein attendees of events are able to discover additional activities based on their preferences and needs for accommodation. Additionally, in the current environment, there is a need to see what COVID-19 precautions are necessary in order to attend an event or venue and to learn the compliance with COVID-19 precautions by other attendees of the events, as well as past compliance with COVID-19 precautions by the venue, to make informed decisions about attending events.

Referring now to the drawings in general, the illustrations are for the purpose of describing one or more preferred embodiments of the invention and are not intended to limit the invention thereto.

The present invention includes a server platform including at least one server having at least one processor and at least one database. The server platform is in network communication with a plurality of user devices (e.g., mobile phones, computers, tablets, smart watches, etc.). In one embodiment, the server platform is configured to provide graphical user interfaces (GUIs) to the plurality of user devices when the plurality of user devices access at least one application interface (e.g., a mobile app, a website, etc.). The GUI is operable to facilitate curating events or activities in real-time or near real-time and discovering complementary or related events, activities, and services in real-time or near real-time based on user entertainment preferences, health and safety preferences, and lifestyle preferences. As used herein, the term “event” indicates any planned private or public occasion or activity, including concerts, plays, movies, sporting events, performances, hiking, kayaking, golfing, sightseeing, tours, or any other indoor and/or outdoor action participated in socially or alone.

The server platform is operable to provide a login and/or an account generation screen on the GUI. The server platform is configured to receive at least one profile set-up message from at least one user device, and generate a user profile based on the at least one profile set-up message. In one embodiment, the at least one profile set-up message includes a user name, a password, an email address, disability information, allergy information, a birth date, answers to challenge questions, biometric data, geolocation data, a phone number, and/or other personal identification information. In another embodiment, the login and/or account generation GUI includes at least one third-party social media application programming interface (API). Through the at least one third-party social media API, the server platform is configured to receive account information from a third-party social media application (e.g., TWITTER, LINKEDIN, FACEBOOK, GOOGLE, APPLE, INSTAGRAM, REDDIT, etc.) associated with the user device. In one embodiment, based on the account information received from the third-party social media application, the server platform is operable to automatically generate a user profile.

In one embodiment, the server platform is operable to receive at least one lost password and/or lost username request message through the login and/or account generation GUI. In one embodiment, in response to the at least one lost password and/or lost username request message, the server platform prompts for additional account information, provides challenge questions to the user device, and/or prompts for additional authorization (e.g., biometric authentication, two-factor authentication, etc.) for the account. Upon receipt of additional account information, correct answers to challenge question, and/or additional authorization, the server platform is operable to transmit a code and/or a link used to reset a username and/or password to an email address, a phone number, and/or an alternative contact means associated with the user profile.

In one embodiment, each user profile generated on the server platform includes at least one unique referral code. In one embodiment, the at least one unique referral code includes at least one character string, at least one QR code, at least one bar code, and/or other identifying information. When a new user profile is generated, if the at least one unique referral code of an existing user is scanned and/or entered by a user associated with the new user profile, then the server platform automatically provides reward points to the user profile associated with the at least one unique referral code. In one embodiment, at least one dashboard associated with the user profile displays a number of points earned and/or a number of individuals referred through the server platform. In one embodiment, reward points are also provided based on daily usage of an application associated with the server platform and/or attendance at specific events and/or venues. In one embodiment, the reward points are able to be redeemed for cash or other rewards through the server platform via a link to a bank account or an account of other financial institution. Alternatively, reward points are provided as a cryptocurrency, such as a native, in-app cryptocurrency, which are redeemable through the application for tickets and/or other merchandise.

In one embodiment, each user profile is associated with a user timeline. The timeline includes a graphical display of events created, liked, loved, or attended by a user profile distributed along a time axis, indicating when the event occurred, started, or ended. In one embodiment, the timeline also includes other content created by each user profile, including recorded video and/audio, and/or text documents generated or uploaded by the user profile. This allows other users to follow the activities of the user profile and view what things each user has participated in.

In one embodiment, the server platform receives a request to delete a user profile. In one embodiment, the server platform transmits a confirmation message to a device associated with the user profile, in order to ensure that the deletion is intended. If the server platform receives confirmation, the user profile is removed from a database associated with the server platform. In one embodiment, the user profile and any information associated with the user profile is deleted within 24 hours of confirmation. In one embodiment, the same user details (e.g., email address, phone number, device identification number, etc.) are not able to be used again to generate a new user profile after deletion.

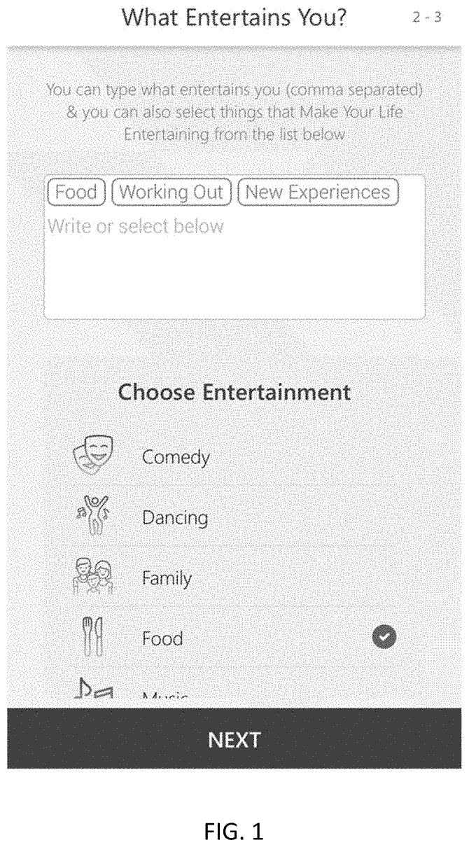

FIG. 1 illustrates an entertainment preference selection GUI according to one embodiment of the present invention. In one embodiment, the server platform provides an entertainment preference selection GUI to one or more user devices. Through the entertainment preference selection GUI, the server platform is operable to receive a selection of forms of entertainment that are able to be “preferred” by each user profile, generating entertainment preference data that is associated with each user profile. In one embodiment, the server platform provides a textbox GUI operable to receive user-generated entertainment forms. In one embodiment, forms of entertainment in the textbox are delineated by comma separation. In another embodiment, the server platform provides a list of a plurality of forms of entertainment (e.g., comedy, dancing, family, food, music, networking, new experiences, sports, working out, etc.) and is operable to receive a selection from a user device through the GUI of one or more forms of entertainment from the list. In another embodiment, the textbox is operable to receive customized user input such as user inputted text, and utilize AI algorithms such as natural language processing (NLP) algorithms to suggest entertainment for the user. In another embodiment, the server platform is configured to receive information from a third-party social media application (e.g., TWITTER, LINKEDIN, FACEBOOK, GOOGLE, APPLE, INSTAGRAM, REDDIT, etc.), extract preference or interest information from social media profiles, social media event attendance history or other application event attendance history (such as EVENTBRITE history, LIVENATION ticket purchases, etc.), or receive location information such as information obtained from GOOGLE MAPS, APPLE MAPS, LYFT, UBER, etc. to determine past locations visited and interests, events, or venues associated with those locations.

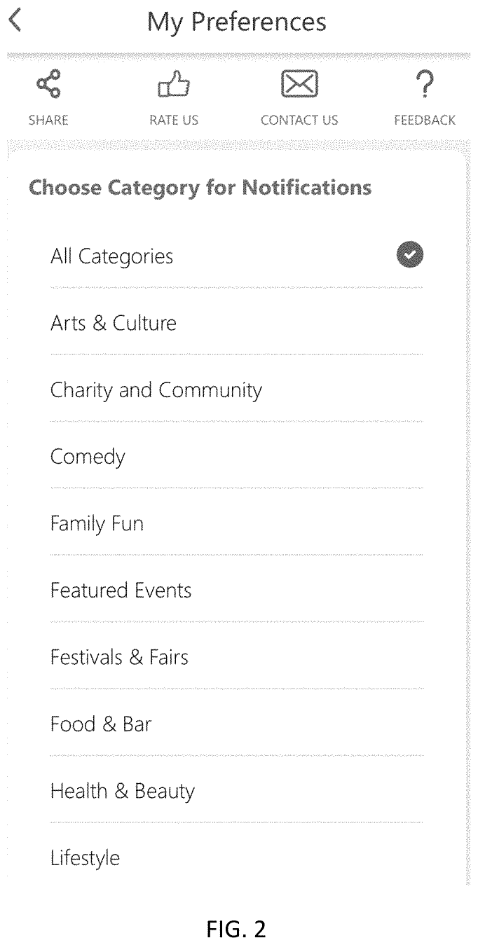

FIG. 2 illustrates an entertainment event preference selection GUI for notification of events according to one embodiment of the present invention. In one embodiment, the server platform provides an event preference selection GUI to one or more user devices. Through the event preference selection GUI, the server platform is operable to receive a selection of types of events that are preferred by each user profile and entertainment categories the user is interested in obtaining notification for, thereby generating event preference data that is associated with each user profile. In one embodiment, the server platform provides a list of a plurality of types of events (e.g., Arts & Culture, Charity and Community, Comedy, Family Fun, Festivals & Fairs, Food & Bar, Health & Beauty, Lifestyle, Miscellaneous, Music, Networking and Meetups, Nightlife and Social, Outdoors, Science/Tech, Sports, Theater/Performance, Travel & Tours, Virtual/Online Events, etc.) and is operable to receive a selection from a user device of one or more forms of entertainment from the list.

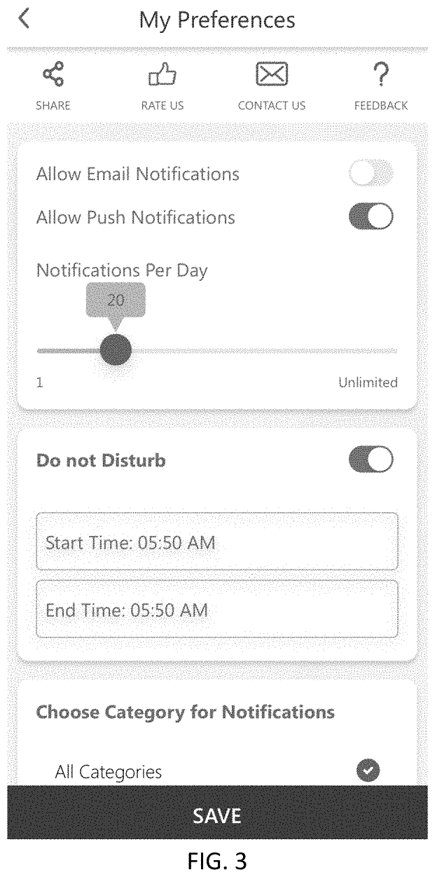

FIG. 3 illustrates a notification settings GUI according to one embodiment of the present invention. In one embodiment, for events tagged with one or more of the types of events preferred by a particular user profile, the server platform automatically transmits an alert to a user device associated with the particular user profile (e.g., via text message, email, smartphone popup notification, etc.). In one embodiment, the server platform is operable to receive a selection of one or more types of notifications that are able to be sent a user device (e.g., email notification, text notifications, push notifications on a mobile device, or both). In one embodiment, the server platform is operable to receive a selection for a frequency of alerts, such as the maximum number of notifications overall that are able to be sent to a user device per day and/or the amount of number of notifications for a specific event that are able to be sent to a user device per day. In one embodiment, the server platform is operable to receive a selection from a user device for a user profile to enter Do Not Disturb mode for an amount of time. During Do Not Disturb mode, user devices associated with the user profile are not sent notifications by the server platform.

In one embodiment, the server platform only transmits an alert to a user device regarding a particular event when the event is within a preset distance from the geolocation of the user device (e.g., within 1 mile, within 2 miles, within 5 miles, within 10 miles, within 50 miles, within 100 miles, within 500 miles, within 1,000 miles, etc.). In another embodiment, the server platform only transmits an alert to a user device regarding a particular event when the event is in the same locality as the user device (e.g., in the same city, in the same state, in the same country, etc.). In one embodiment, the server platform is operable to receive a location selection setting from one or more user devices, wherein the location selection setting includes distances and/or localities within which events will generate alerts. In one embodiment, the server platform informs a user device of an alert at a predetermined time interval before an event (e.g., 10 minutes, 15 minutes, 30 minutes, 1 hour, 3 hours, 8 hours, 12 hours, 24 hours, 3 days, 5 days, 1 week, etc.). In one embodiment, the server platform is operable to receive an alert timing selection setting from one or more user devices, wherein the alert timing selection setting includes a predetermined time before an event to provide an alert. In one embodiment, geolocation data for each user device is generated based on Global Positioning System (GPS) data, Global Navigation Satellite System (GNSS) data, proximity to one or more designated beacons (e.g., IBEACON), and/or any other geolocation system. Beacons and BLUETOOTH® technology are also operable to be utilized by merchants and vendors to send push notifications to devices running the application of the present invention with advertisements, offers, and other content.

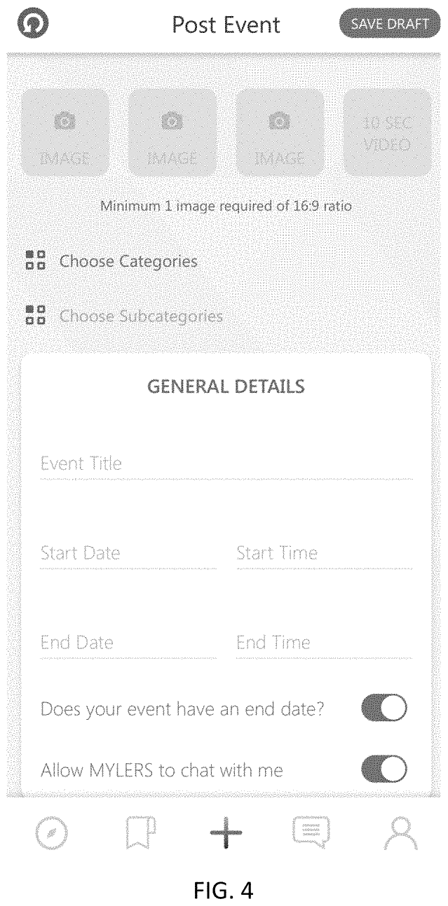

FIG. 4 illustrates an event creation GUI according to one embodiment of the present invention. In one embodiment, the server platform provides an event creation GUI to one or more user devices. In one embodiment, through the event creation GUI, the server platform is operable to receive an event title, a start date, an end date, a start time, an end time, a location, a short description, a detailed description, one or more images, one or more videos, one or more category labels, one or more subcategory labels, a minimum price to attend, a maximum price to attend, a selection to make the event free, and/or other information regarding an event. In one embodiment, events are able to be saved as drafts, such that the events are not made publicly available, but the user profile creating the event is able to return to it and edit it further at a later time. In one embodiment, the server platform is operable to receive a selection to provide the event with an end date or not to provide the event with an end date. In one embodiment, if the event is not provided with an end date, then it is automatically designated as “ongoing” or “continuous.” In one embodiment, the location of the event is selected as a location on a physical map interface (e.g., GOOGLE MAPS, APPLE MAPS, etc.). In one embodiment, the location of the event is designated as at least one virtual space (e.g., a ZOOM call, a GOOGLE MEET, at least one Metaverse environment, at least one online game, etc.). The present invention provides for interaction within these environments, such as within a Metaverse environment, for hosting of events within the environment, promotion of events within the environment, selling of tickets for an event within the environment, and capture data of attendees of events within the environment.

In one embodiment, through the event creation GUI, the server platform is operable to receive a selection regarding whether other users are able to initiate chat messages with the event creator. If an event allows other users to initiate chat messages, then the server platform provides a selectable icon associated with the event to initiate a chat and/or to provide contact information for the creator of the event. If an event disallows other users to initiate chat messages, then no contact information or capabilities are provided for the event. In one embodiment, the server platform or device is operable to import event information from a website or another application, such as a FACEBOOK EVENT, an EVENTBRITE event, or an event described on a website.

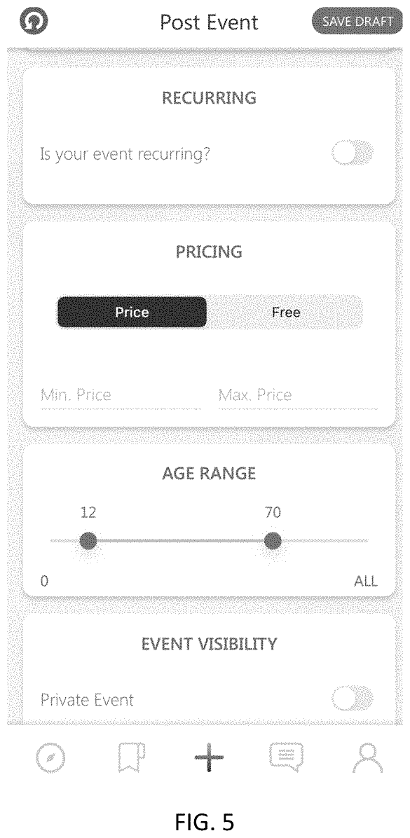

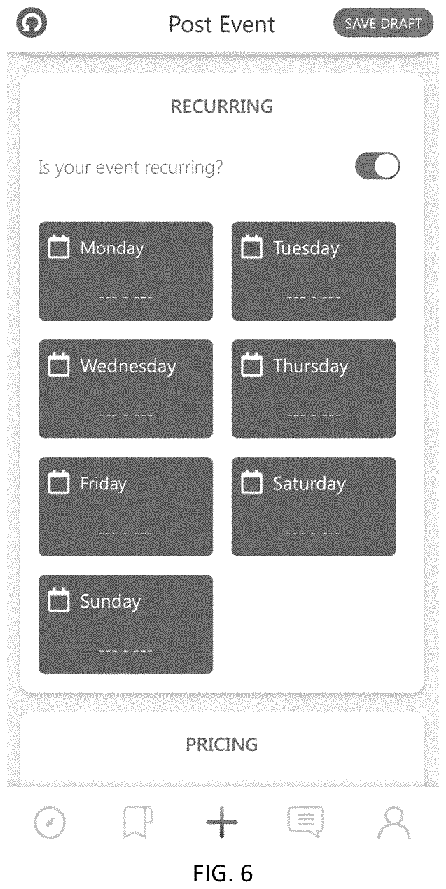

As shown in FIGS. 5 and 6, in one embodiment, through the event creation GUI, the server platform is operable to receive a selection to make the event recurring. If a selection to make the event recurring is received, then the event creation GUI prompts for an input of a day of the week and/or a time of day during which the event will take place. By way of example and not of limitation, if an event is selected to recur on Fridays at 2 PM, then the server platform will display the event as occurring every Friday at 2 PM until the event is edited or destroyed.

In one embodiment, through the event creation GUI, the server platform is operable to receive a selection of an age range for an event. In one embodiment, age range selection is received through an interactive slider element. In one embodiment, the age range is a suggested age range and is automatically added to a list of details regarding the event. In another embodiment, the server platform only presents events for users wherein the events match the age range of the user. By way of example and not of limitation, in one embodiment, if a user profile designates a user has having an age of 18 and the age range of a first event is 21 years or older, then the first event will not appear to the user profile for the user aged 18.

In one embodiment, through the event creation GUI, the server platform is operable to receive a selection to make an event private. In one embodiment, if an event is selected to be private, then the server platform is operable to receive a selection of specific other people to invite to the event via, for example, a list of designated email addresses, phone numbers, and/or profile names for each designated invitee. In another embodiment, if an event is selected to be private, then the server platform is operable to receive a passcode associated with the event. In one embodiment, the server platform presents events designated as private to all users, but only enables users to see details regarding the event (e.g., timing, location, etc.) to a user device if the server platform receives a passcode associated with the event from the user device. In one embodiment, if an event is not selected to be private, then the server platform publicly displays the event and provides details regarding the event to all user devices.

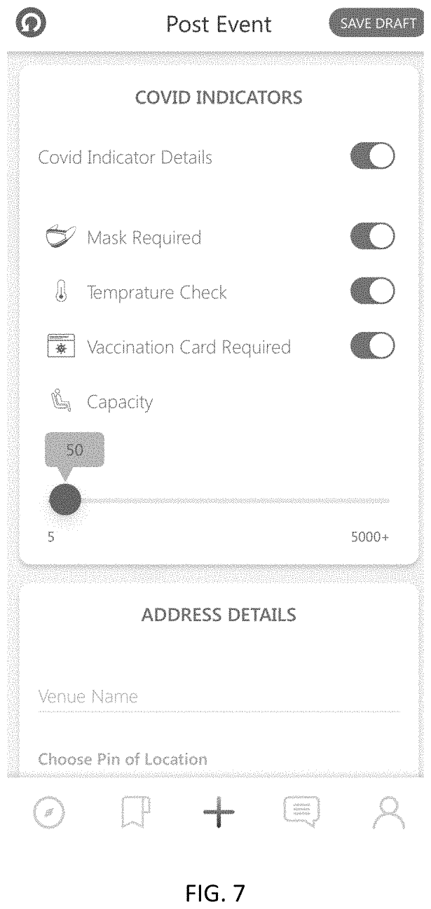

In one embodiment, through the event creation GUI, the server platform is able to receive a selection of one or more allergy risks for an event and/or venue (e.g., high peanut allergy risk, high pollen risk, etc.). In another embodiment, the event creation GUI allows for the selection of one or more environmental and/or dietary statuses (e.g., non-GMO, gluten-free, vegan, vegetarian, etc.). In yet another embodiment, as shown in FIG. 7, the event creation GUI allows for the selection of one or more pandemic policies (e.g., mask required, mask optional, vaccination required, vaccination optional, proof of vaccination such as a vaccination card required, proof of a certain type of vaccination such as MODERNA vaccination, PFIZER vaccination, or JOHNSON & JOHNSON vaccination required, negative COVID test required within a certain time period before the event, temperature check required, temperature check not required, maximum capacity settings, etc.). In still another embodiment, the event creation GUI allows for the selection of one or more disability accommodations (e.g., inclusion of ramps, braille menus, service animal-friendly, etc.). In yet another embodiment, the event creation GUI allows for selection of one or more lifestyle accommodations (e.g., dog-friendly, alcohol friendly, vape friendly, child friendly, etc.). In one embodiment, the event creation GUI allows for the selection of a maximum number of attendees, a size of the venue, and/or an expected density of attendees at the event. In one embodiment, the expected density is represented as low, medium, or high. The GUI is also operable to provide a safety level for an event or venue based on health and safety measures taken by the venue or observed at the venue, with a red safety level indicating the most unsafe, a yellow safety level indicating a need for caution, and a green safety level indicating the venue or event is projected to be safe.

In one embodiment, the server platform is operable to collect data regarding the geolocation of a plurality of individuals who possibly came into contact with one or more infectious disease from at least one contact tracing application. Furthermore, in one embodiment, the server platform is operable to automatically flag specific events and/or venues as potentially being hotspots for the infectious disease. By way of example and not of limitation, in one embodiment, the server platform automatically provides a notification indicating the presence of a suspected infected individual to a given event and/or location within a preset time period (e.g., 30 minutes before, 1 hour before, 3 hours before, 8 hours before, 12 hours before, 24 hours before, etc.) to all individuals within a predetermined range of the event and/or location, to all individuals who have liked the event and/or location, to all individuals who have loved the event and/or location, and/or to all individuals who have stated they plan to attend the event and/or location. Examples of contact tracing systems able to integrate with the system described by the present application include, but are not limited to, those described US Patent Publication No. 2017/0024531, which is incorporated herein by reference in its entirety.

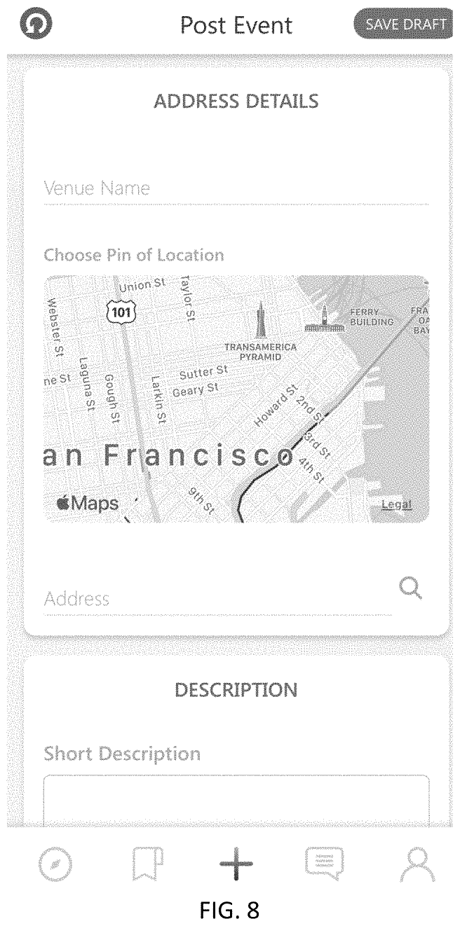

In one embodiment, as shown in FIG. 8, which is a continuation of the GUI of FIG. 7, the event creation GUI includes a map API. In one embodiment, the map API includes an embedded interactive map provided by a third-party map generating program (e.g., GOOGLE MAPS, APPLE MAPS, WAYMO, GARMIN, etc.). In one embodiment, through the event creation GUI, the server platform is able to generate a location for an event via receiving an address for the event and/or through receiving a pin dropped on the embedded interactive map.

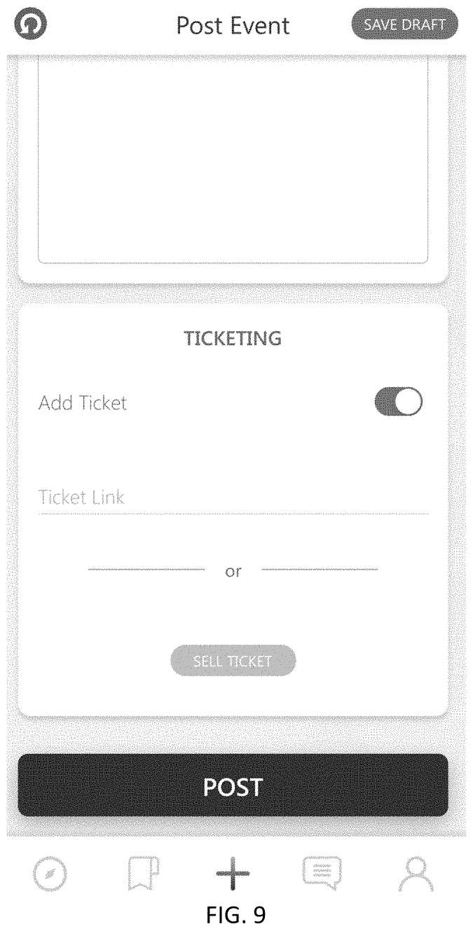

FIG. 9 illustrates a continuation of the event creation GUI of FIG. 8 with ticketing features according to one embodiment of the present invention. In one embodiment, through the event creation GUI, the server platform is operable to receive a ticketing link associated with the event (e.g., LIVENATION, EVENTBRITE, TICKETMASTER, STUB HUB, etc.). In one embodiment, the event creation GUI includes an API operable to collect information relating to the linked ticketing website and display the information in association with the created event. By way of example and not of limitation, the API is operable to collect information regarding the number of tickets sold, the number of tickets still available, locations of remaining tickets, and/or an image related to the event. In one embodiment, the ticketing link determines where a user device is redirected when a user device selects an option to buy a ticket related to an event. In another embodiment, the selection of an option to buy a ticket does not redirect the user device, but instead initiates an API call to the ticketing link that automatically purchases the ticket and displays on the user device that the purchase was successful. Usefully, this allows purchases related to the event to occur within the application, rather than requiring the user to navigate another website or application. In one embodiment, a ticket is operable to be selected for purchase as a general admission ticket, by seat, by row, or by section.

In one embodiment, the server platform is integrated with at least one third party event database (e.g., the OHIO EVENT FINDER). The server platform automatically brings in one or more events from the at least one third party event database to automatically populate events listed on the server platform. In one embodiment, the server platform includes at least one API operable to receive a user account for a third party application including one or more events associated with the user account for the third party application. The server platform automatically adds the events associated with the user account to the user profile generated on the server platform, thereby automatically allowing a user to aggregate their personal events and event calendars through the application. In one embodiment, the at least one API automatically checks at preset intervals (e.g., every day, every week, every month, etc.) for new events associated with the user account for the third party application and automatically imports those events to the server platform. This prevents users of both applications from having to repost events or attendance in events multiple times, and instead allows changes in one application to show in both applications.

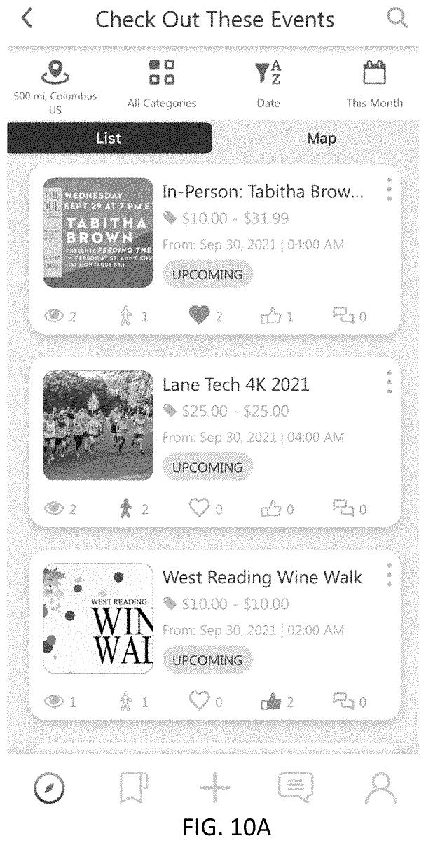

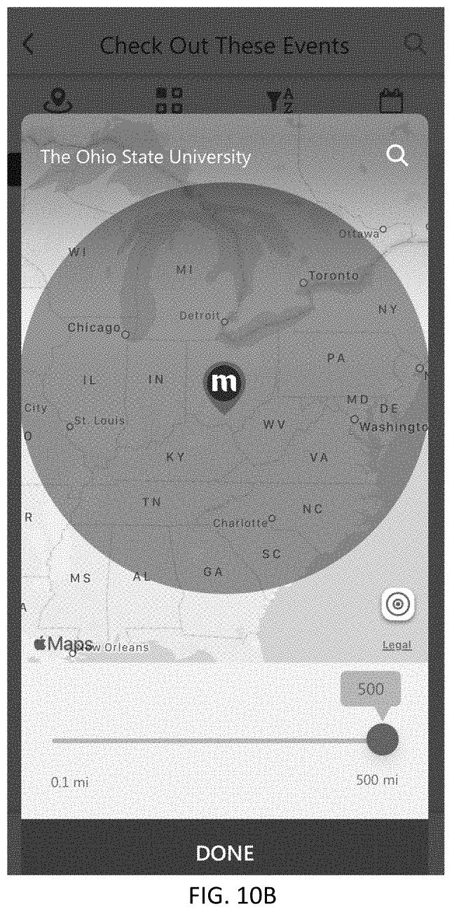

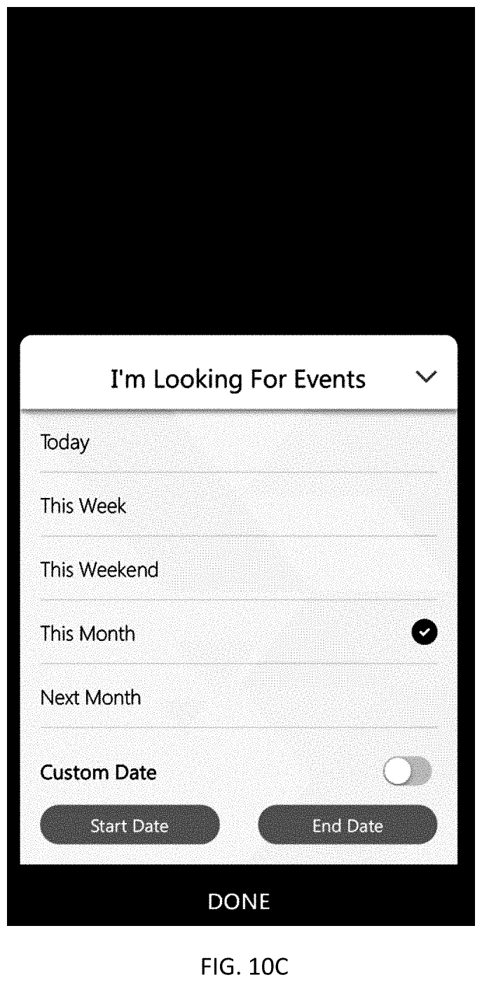

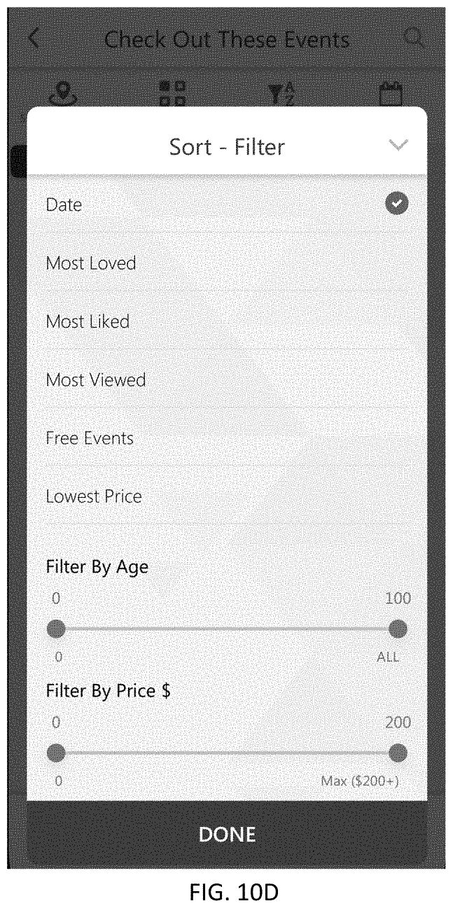

FIG. 10A illustrates a venue and/or event suggestion GUI according to one embodiment of the present invention. In one embodiment, the server platform provides a venue and/or event suggestion GUI to one or more user devices. The venue and/or event suggestion GUI provides a custom-tailored list of nearby events for each user. The list of events is operable to be updated in near real-time or real-time, based on geolocation, the newness of events, an event being amplified by an event creator, or real-time or near real-time health and safety information provided by attendees at an event or a venue. In one embodiment, the server platform includes an artificial intelligence module, which includes a machine learning module in one embodiment. The artificial intelligence module generates a list of events based on entertainment preference data, event preference data, historical data (e.g., previously attended events by a user profile), like data (e.g., events “liked” by a user profile), love data (e.g., events “loved” by a user profile), lose data (e.g., events that a user profile chose to “lose”), dislike data (e.g., events “disliked” by a user profile), age data, time preference data (e.g., times during which a user profile is willing to go to events), pandemic compliance information (e.g., habits and preferences for pandemic compliance factors associated with a user profile), disability information associated with a user profile, and/or location data. Machine learning is utilized in one embodiment to provide the curated or custom-tailored list of events. In one embodiment, the venue and/or event suggestion GUI includes information for each listed event, including an associated image, a name, a cost, a date, a time range, whether the event is recurring, the number of people looking at the event, the number of planned attendees, the number of “love” reactions to the event, the number of “lose” reactions to the event, the number of like reactions to the event, the number of dislike reactions to the event, and/or the number of comments regarding the event. In one embodiment, the present invention uses metatags for events or activities based on the event type, location, or other information associated with the events or activities to associate metatags with a user profile and provide recommendations using machine learning or artificial intelligence. By way of example and not limitation, a hip-hop concert at Newport Music Hall in Columbus, Ohio includes the metatags “music”, “hip-hop”, “Columbus”, and “Newport Music Hall”. By comparing these metatags with other metatags for other events or activities a user profile has participated in using machine learning or artificial intelligence, the present invention provides for improved recommendations for future events or activities for a user profile based on the metatags of the prior events and activities and the metatags for the future events or activities. In one embodiment, the recommendations are included in a recommendations section of the application and are updated based on the geo-location of the device associated with the user profile.

In one embodiment, the server platform is operable to receive at least one filter selection for the venue and/or event suggestion GUI from a user device. The server platform limits the listed events based on the at least one filter selection. In one embodiment, as shown in FIG. 10B, the at least one filter selection includes at least one filter based on distance to a particular location (e.g., a user's location). In another embodiment, as shown in FIG. 10C, the at least one filter selection includes a filter based on the time of the event. In yet another embodiment, as shown in FIG. 10D, the at least one filter selection includes a filter based on type of event, a filter based on an age range of the event, and/or a filter based on the price of the event. In still another embodiment, the at least one filter selection includes a filter based on the time of the event, a filter based on star ratings, a filter based on pandemic compliance ratings, a filter based on disability accommodation ratings, a filter based on one or more specific pandemic compliance practices, a filter based on one or more specific disability accommodation practices, a filter based on expected attendee density, and/or a filter based on any other aspect of the event. In one embodiment, if the server platform receives a selection from a user profile to “lose” an event and/or venue, then that event and/or venue no longer appear to the user profile.

In one embodiment, the server platform generates communities associating a plurality of user profiles. In one embodiment, the server platform assigns each user profile to one or more communities based on selections to join a specific community received from the user profile. In one embodiment, the server platform automatically assigns each user profile to one or more communities based on events each user profile has liked, events each user profile has loved, events each profile has stated they plan on attending, events each profile has an associated ticket to attend, venues each user profile has liked, venues each user profile has loved, and/or other facets of each user profile.

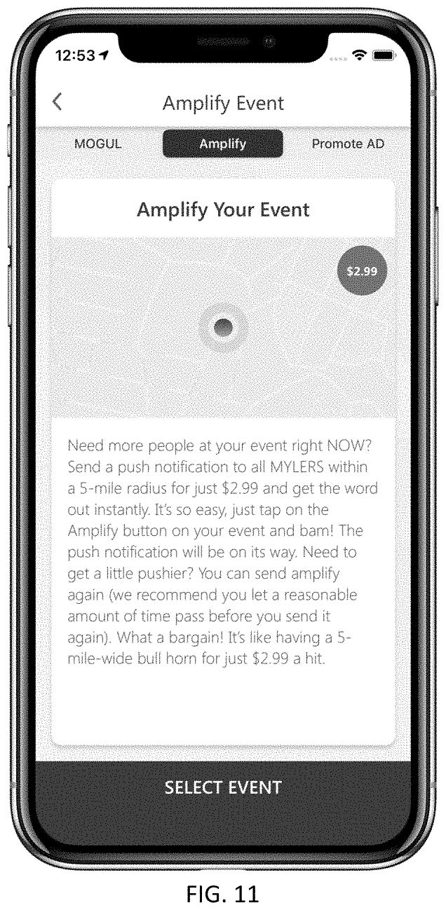

FIG. 11 illustrates an event amplification GUI according to one embodiment of the present invention. In one embodiment, the server platform is operable to receive a selection to amplify a user profile. In one embodiment, when suggesting nearby events to users, the artificial intelligence module also takes into account whether the user profile that created each event has been amplified. In another embodiment, the server platform is operable to receive a selection to amplify individual events. In one embodiment, amplified events always appear at the top of the custom-tailored list of nearby events. In another embodiment, the server platform automatically sends notification to nearby users when an amplified event is about to occur. In a preferred embodiment, the GUI receives user input to amplify an event and transmits a push notification to users within a certain radius (such as a 5 mile radius, 50 mile radius, etc.) of an event. In one embodiment, amplification is also made based on non-geolocation-based criteria. In one embodiment, amplification of an event causes a push notification to be sent to all user profiles that are members of one or more communities designated by the event amplifier. For example, an event if amplified such that all planned attendees of a specific concert receive the push notification. In one embodiment, each community has at least one community partner, wherein events created or posts made by the at least one community partner are automatically amplified to the entire community. In one embodiment, only the at least one community partner is able to amplify posts to the entire community. The amplification of an event is made in exchange for a fee from the event host in one embodiment. One of ordinary skill in the art will understand that the specific radius within which push notifications are to be transmitted is not intended to be limiting according to the present invention.

In one embodiment, the server platform is operable to receive a selection to make a user profile a mogul. In one embodiment, events created by user profiles designated as moguls are able to be designated with a unique “featured” category. In one embodiment, the venue and/or event suggestion GUI includes at least one filter to only display events in the featured category. In one embodiment, mogul status is provided on a subscription basis in exchange for a recurring fee. In another embodiment, mogul status is earned based on incentivized activity within the app, such as by providing information on a certain number of events or venues. In yet another embodiment, the mogul status provides for eight free amplification events with a one month subscription and one hundred free amplification events with a yearly subscription. Push notifications for events which are amplified by mogul users are operable to be pushed to devices within a larger radius of the event than amplifications provided by non-mogul users. For example, in one embodiment, notifications about a mogul amplified event are pushed to devices within a 50 mile radius instead of a notification about a regular user amplified event, which are only pushed to devices within a 5 mile radius. Mogul status also provides for a video relating to the event to be included on the event page and/or pushed to user devices within a certain radius of the event.

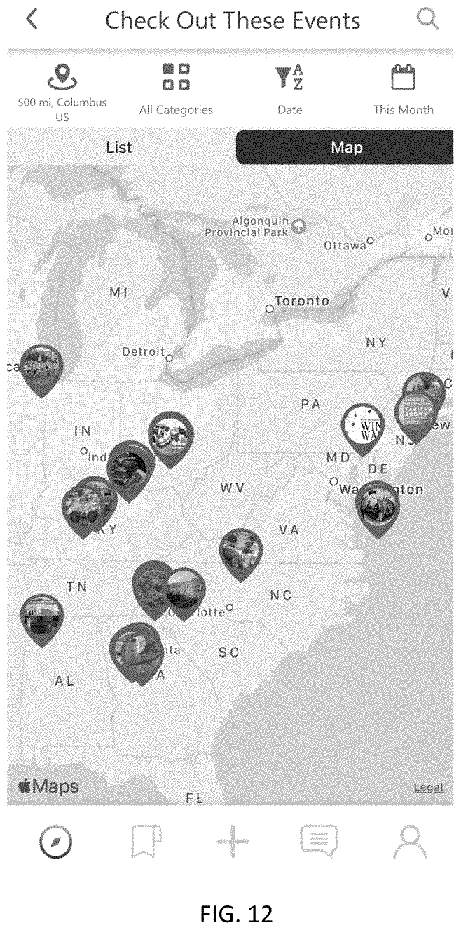

FIG. 12 illustrates a venue and/or event map GUI according to one embodiment of the present invention. In one embodiment, as shown in FIG. 12, the server platform is operable to generate at least one interactive map displaying each suggested event. In one embodiment, each suggested event is displayed using a pin and/or an associated image for the event at a location on the interactive map associated with the event. In one embodiment, the interactive map is able to be zoomed in and/or zoomed out. In one embodiment, the interactive map is generated by a third-party map application. In one embodiment, the venue and/or event map GUI receives an input selecting at least one filter for events shown on the interactive map. In one embodiment, the filter limits events shown on the interactive map based on date (e.g., only today, this week, this weekend, this month, next month, and/or other date selections), category, or cost (only free events, only events below a preset cost, etc.). In one embodiment, the venue and/or event map GUI receives an input selecting at least one sort (e.g., date, most loved, most liked, most viewed, lowest price, etc.) for events shown on the interactive map. In one embodiment, the size of markers representing each event on the interactive map changes based on the sort. For example, if the sort is by date, those events occurring sooner appear larger on the map, while those that are less soon are smaller.

The present invention is also operable to suggest one or more itineraries including multiple events and/or activities for user profiles based on a specified location and a budget. The one or more itineraries are customizable based on user preferences, and provide for purchase of multiple event or activity tickets, lodging, and/or transportation simultaneously.

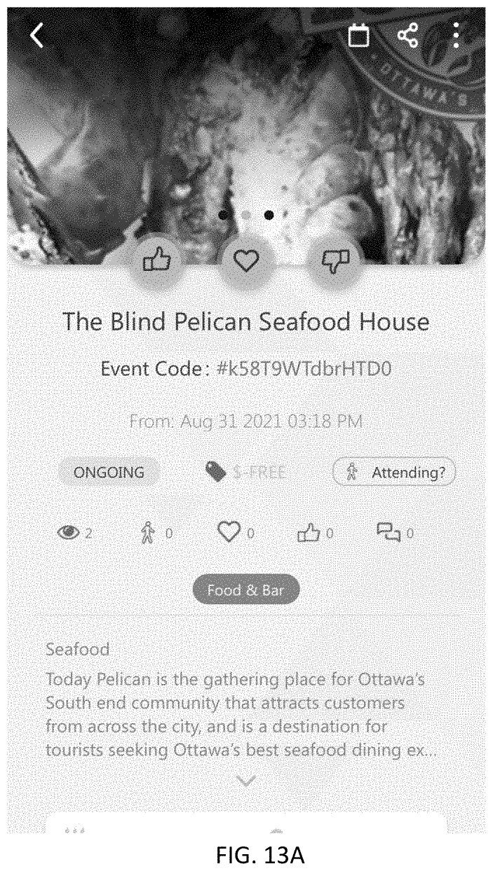

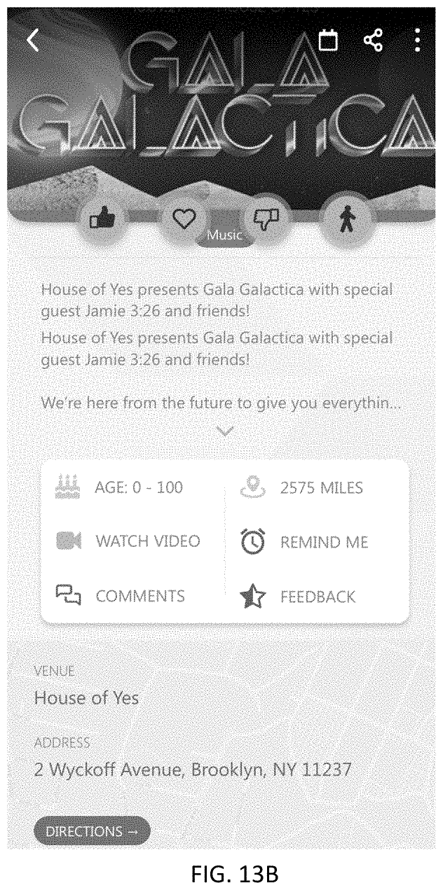

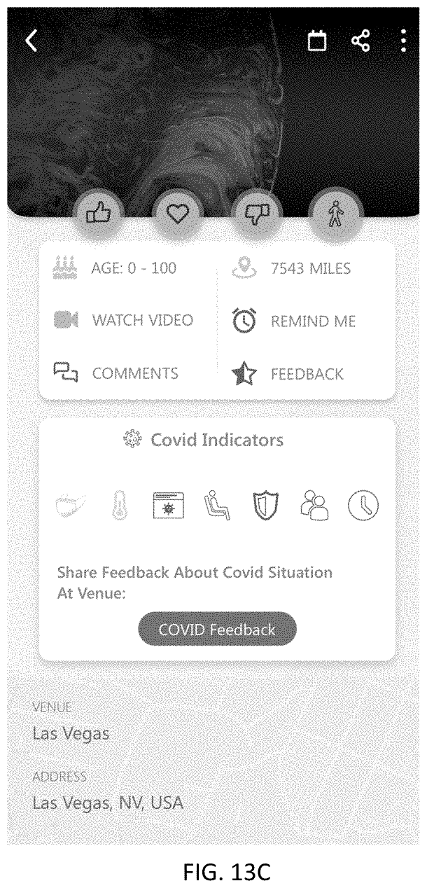

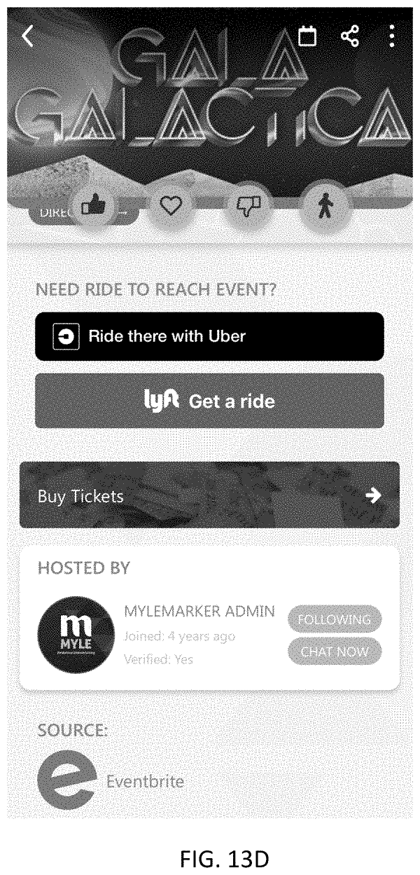

FIGS. 13A and 13B illustrate a venue and/or event detail GUI according to one embodiment of the present invention. In one embodiment, the server platform provides a venue and/or event detail GUI to one or more user devices upon receiving a selection of a venue or event. The venue and/or event detail GUI provides information concerning a venue and/or event, including a name, an event code, a date, a time, a location, a cost, a number of attendees, a number of “likes,” a number of “loves,” the number of “lose” reactions, a number of “dislikes,” a numerical rating, a star rating, a pandemic compliance rating, a disability accommodation rating, a list of pandemic-related requirements, a list of disability accommodations, a category of event and/or venue, a subcategory of event and/or venue, a brief description, a detailed description, an age range, a distance from current location, one or more associated images, one or more associated videos, one or more comments, an average numerical feedback, and/or contact information for a creator of the event. In one embodiment, the venue and/or event detail GUI includes a search functionality by which a user profile is able to search for an event based on the name, event code (a unique code for each event that is able to be shared with potential attendees in order to more easily identify the event), and/or location of the event. Through the venue and/or event detail GUI, the server platform is operable to receive a selection to react to the venue and/or event detail. Reactions include, but are not limited to, like, dislike, love, lose, hate, happy, angry, sad, planning to attend, may be will attend, and/or will not attend. In one embodiment, each user profile is limited to providing one reaction of each type. In another embodiment, each user profile is limited to providing one reaction overall. In one embodiment, the server platform is operable to receive a selection of a numerical rating for each event (e.g., number of stars and/or half-stars out of 5, rating on a scale of 1 to 10, rating on a scale of 1 to 100, etc.).

In one embodiment, through the venue and/or event detail GUI, the server platform is operable to receive a selection of a rating for a venue and/or an event for specific factors. By way of example and not of limitation, in one embodiment, as shown in FIG. 13C, the server platform is able to receive a pandemic compliance rating (e.g., average mask usage rate, average vaccination rate of customers and/or staff), and/or a disability accommodation rating (e.g., ability to cater to various physical and/or mental disabilities, attitudes of staff and/or other customers toward people with physical and/or mental disabilities, etc.). In one embodiment, the feedback is provided via a numerical indicator, such as a rating from 1 to 100, by a binary feedback mechanism (e.g., thumbs up or thumbs down), a star rating (such as a rating from one to three stars or one to five stars), or any other mechanism known in the art. The feedback preferably updates the rating of the venue in real-time or near real-time. This near real-time or real-time update is advantageous because it provides for people who are considering attending an event or going to a venue to determine if the event or venue is safe. In one embodiment, a profile includes a health and safety risk profile, and an alert is delivered as a push notification or an email notification if an event a user is planning on attending surpasses the risk profile of the user. In one embodiment, venues and/or events are color coded based on pandemic compliance rating and/or disability accommodation rating (e.g., red indicates poor compliance, yellow indicates moderate compliance, green indicates good compliance, etc.).

In one embodiment, through the venue and/or event detail GUI, the server platform is operable to receive a wait time for each attendee of an event. In one embodiment, the server platform is operable to use an artificial intelligence algorithm to determine a projected wait time based on a projected or actual number of attendees at the event or venue and past wait times of attendees at the event or venue. Based on the received wait time for each attendee, the server platform is operable to generate an expected wait time for the event and/or future similar events. In one embodiment, the venue and/or event detail GUI includes the expected wait time for the event.

As shown in FIG. 13D, in one embodiment, the venue and/or event detail GUI includes at least one integrated travel & ticket purchase API. In one embodiment, upon selection of the at least one travel API, the server platform transmits a command for the user device to open a separate, third-party travel application (e.g., UBER, LYFT, a taxi application, etc.). In one embodiment, the server platform automatically shares information with the third-party travel application regarding the location of the event described in the venue and/or event detail GUI, such that the location of the event is set as a destination in the third-party travel application. In one embodiment, if a user device is not associated with an account on the third-party travel application, the server platform transmits a prompt for the user to sign-in or create an account on the third-party travel application. Integration of a third-party travel application allows users to more easily make travel plans to attend an event for added convenience. The GUI is also operable to provide ticket purchasing functionality for the event within the application, or to link to a third-party website or app to purchase tickets for the event upon receiving user input to purchase tickets for the event. In one embodiment, upon purchasing tickets for an event, the app is operable to schedule an UBER or LYFT ride from a predetermined location, such as a home location or work location of the user, such that the user will arrive at the event from the predetermined location on time.

In one embodiment, transactions to purchase tickets through the server platform automatically generate virtual tickets associated with each user profile. In one embodiment, the virtual tickets include a name of the event, a seat, one or more images associated with the event, the purchasing party, a time, a date, a number of purchased tickets (i.e., in cases where the virtual ticket represents greater than one physical ticket), one or more unique alphanumerical codes, and/or at least one scannable visual code (e.g., a bar code, a QR code, etc.). This virtual ticket is able to be scanned for attendance at the event.

In one embodiment, the server platform receives designations of individual tickets with one or more different ticket types. In one embodiment, some tickets are designated as “full fee,” which require the full cost of the ticket to be paid by the purchasing user. In one embodiment, some tickets are designated as “partial fee” meaning that the purchasing user pays for a third party processing fee for purchasing the ticket, while the ticket creator pays for the remaining cost (if the tickets are sold by a different party) or the ticket creator waves remaining fees (if the ticket creator is the primary seller). In one embodiment, some tickets are designated as “free” meaning that the ticket creator pays for the full cost or waves any fees required for the tickets. In one embodiment, the server platform is operable to receive a selection to pay more than the required amount for each ticket, wherein the additional fees are designated as donations. In one embodiment, user profiles are given an overall donation level or individual donation levels associated with each seller or event creator. In one embodiment, donation levels are split between different tiers (e.g., bronze, silver, gold, etc.). In one embodiment, users with a higher overall donation level or a higher donation level for a specific seller or event creator are able to purchase different types of tickets (e.g., users with a higher donation level are able to purchase free or partial fee tickets from a particular seller).

In one embodiment, the server platform automatically generates a ticket history for each user profile, including a list of tickets previously purchased and/or used by each user profile. The ticket history allows users to look back on their history of event attendance for the sake of preserving memories and/or other purposes. Each purchased ticket in the ticket history includes the details of the purchase (e.g., number of tickets, price, and event details). Each ticket in the list is selectable via touch screen activation, and provides a digital version of the ticket, such as a PDF file, upon being selected. The digital version of the ticket is operable to be scanned for access to an event on a mobile device such as a smartphone, and is operable to be printed as a hard copy to be scanned.

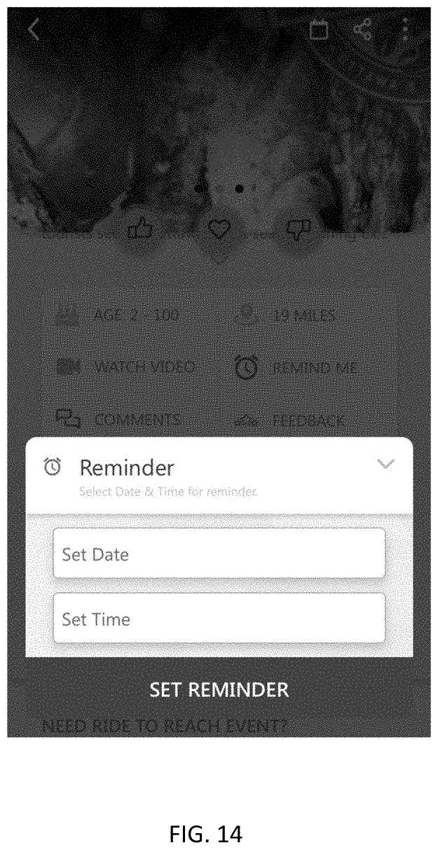

FIG. 14 illustrates an event reminder creation GUI according to one embodiment of the present invention. In one embodiment, the server platform provides an event reminder creation GUI to one or more user devices. Through the event reminder creation GUI, the server platform is operable to receive a selection of a date and a time for a reminder of an event. At the date and time of the reminder, a notification regarding the event is automatically transmitted to a user (e.g., via text message, email, mobile phone popup notification, etc.). In one embodiment, the app is synchronized with a third-party calendaring system such as GOOGLE CALENDAR such that the event reminder is also automatically created on the third-party calendaring system.

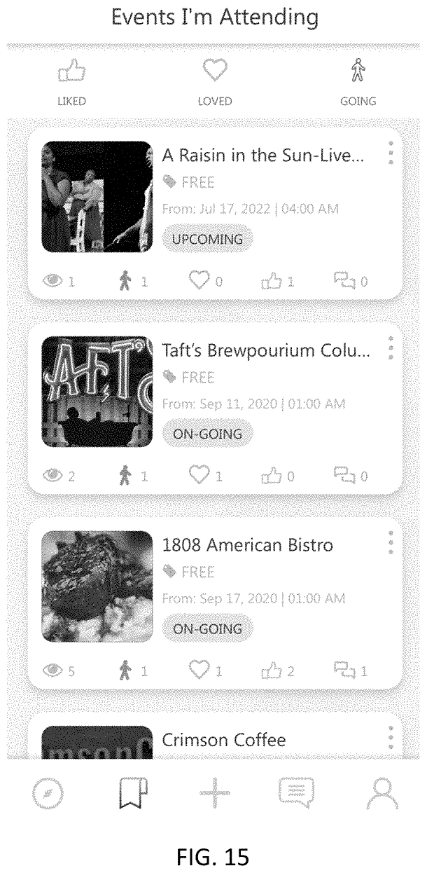

FIG. 15 illustrates_an event management GUI according to one embodiment of the present invention. In one embodiment, the server platform provides an event management GUI to one or more user devices. The event management GUI includes events that a user profile has bookmarked, reacted to and/or has created. This provides added convenience for a user, as the user is able to more easily see what their upcoming schedule looks like, what events they have liked, what events they have loved, and what events they might attend. In one embodiment, the server platform is operable to receive a selection to sort events based on what type of reaction was given to reach event and/or based on whether the user profile has selected that the user will attend the event.

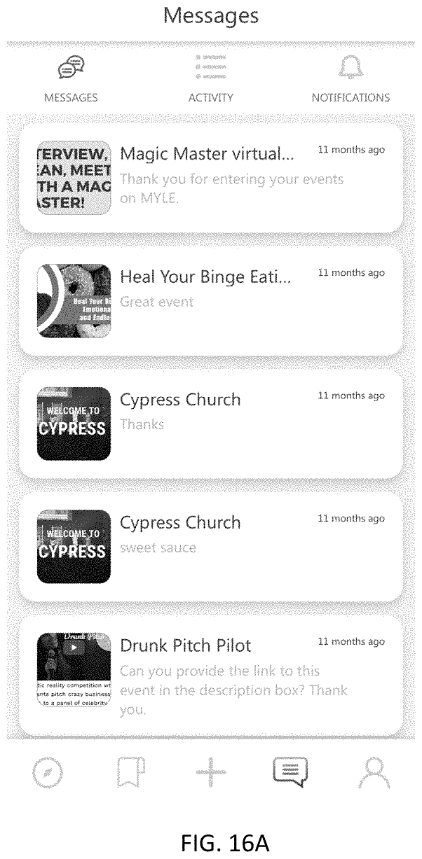

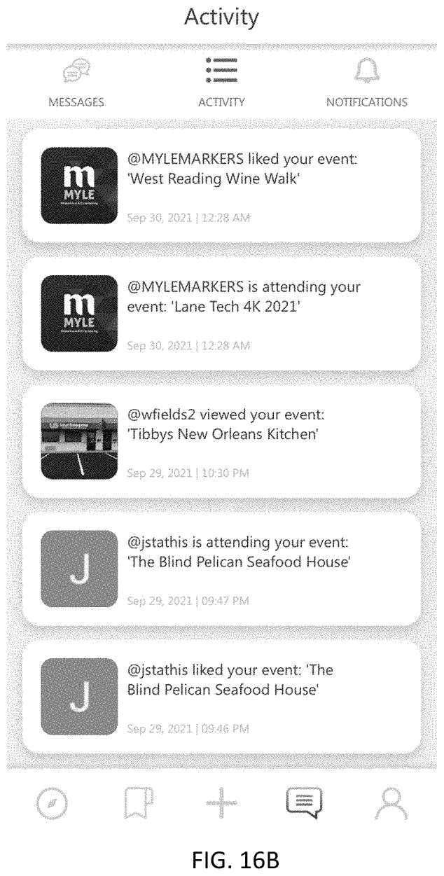

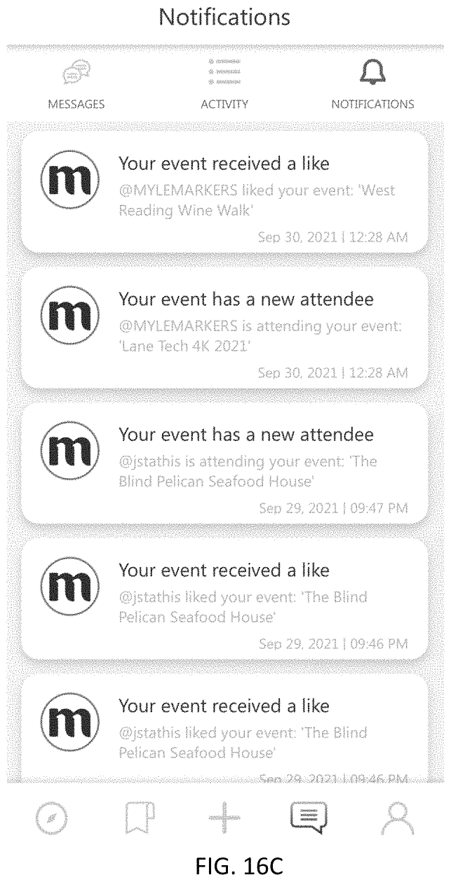

FIG. 16A illustrates a message history GUI according to one embodiment of the present invention. In one embodiment, the server platform provides a message history GUI to one or more user devices. The message history GUI includes a list of past messages sent to and/or received from other users. In one embodiment, through the message history GUI, the server platform is operable to receive a message from one user profile and transmit the message to another user profile in order to facilitate a conversation.

FIG. 16B illustrates an activity history GUI according to one embodiment of the present invention. In one embodiment, the activity history GUI includes a list of past actions taken by a user profile (e.g., a list of reactions given, a list of events attended, and/or a list of events created) and/or a list of past actions performed by other users with regard to an event and/or venue controlled by the user profile.

FIG. 16C illustrates a notification history GUI according to one embodiment of the present invention. In one embodiment, the notification history GUI includes a list of upcoming notifications and/or past notifications.

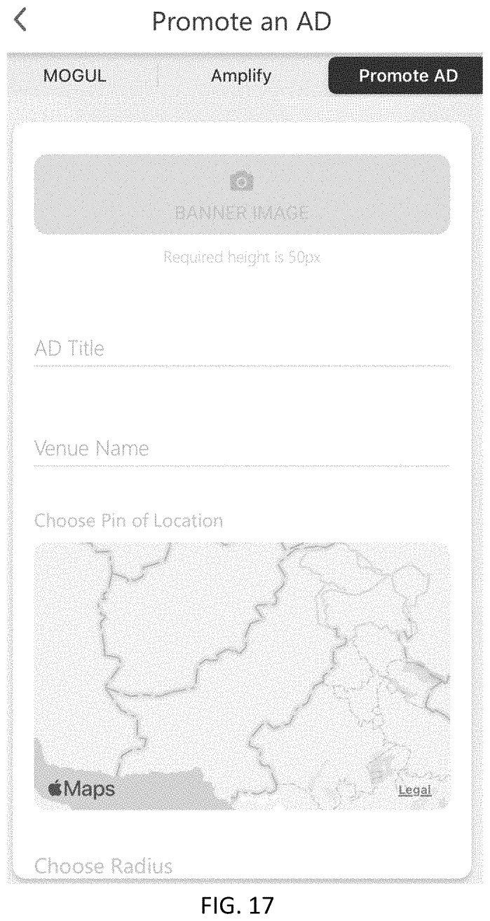

FIG. 17 illustrates an advertisement creation GUI according to one embodiment of the present invention. In one embodiment, the server platform is operable to receive a request from a user device to generate a geotargeted advertisement. In one embodiment, geotargeted advertisements are generated for users within a predetermined distance from an event location, a venue location, and/or a chosen location on a map interface (e.g., within 0.5 miles, within 1 mile, within 2 miles, within 5 miles, within 10 miles, within 20 miles, within 50 miles, etc.). In one embodiment, the request to generate the geotargeted advertisements includes a name of the advertisement, an image to display with the advertisement, a location name, an address, a map pin location, a distance within which the advertisement is transmitted, an advertisement duration, a weblink, and/or a phone number. In one embodiment, the server platform generates the geotargeted advertisement as a banner image at an edge of the display on each user device.

In one embodiment, any transactions conducted with the server platform are able to be conducted with Bitcoin, Ethereum, and/or any other type of cryptocurrency.

In one embodiment, the server platform includes at least one machine learning module. In one embodiment, the at least one machine learning module is configured to identify event and/or venue preferences and/or generate recommendations for each user based on one or more designated preferences for the user profile, one or more past attended events, one or more liked events, one or more loved events, the preferences of one or more other users (e.g., users in a cohort with the user, all users, etc.), and/or a pattern of popularity of one or more categories of events and/or venues. In one embodiment, recommendations are able to be requested and provided through at least one voice assistant (e.g., SIRI, ALEXA, etc.). A voice command to the voice assistant is operable to provide a response from the voice assistant including one or more events or activities, and the voice assistant is operable to accept a selection of an event or activity and facilitate payment for the event or activity and the delivery of an associated ticket to the user profile.

In one embodiment, any link shared with reference to the server platform or for a site or application associated with the server platform is able to be opened in-browser. In one embodiment, if a user device opening the link does not have an application associated with the server platform installed, then the link is automatically opened in a default browser of the user device and the browser opens a webpage or web version of the event or other content. However, if the user device accessing the link does have the application associated with the server platform installed, then the link is automatically opened in the application.

In one embodiment, the server platform includes at least one native streaming application. The server platform receives selections to start recording live video and is able to broadcast that video to any other users on the platform. Furthermore, the server platform is able to record and save the live video for watching later. In one embodiment, the server platform is able to generate one or more voice rooms and/or video rooms, wherein one or more users are able to chat with or without video. In one embodiment, the one or more voice rooms and/or video rooms are able to be recorded by the server platform and saved to a database. In one embodiment, the video room provides for creation of video podcasts and vlogs.

Location data is created in the present invention using one or more hardware and/or software components. By way of example and not limitation, location data is created using the Global Positioning System (GPS), low energy BLUETOOTH based systems such as beacons, wireless networks such as WIFI, Radio Frequency (RF) including RF Identification (RFID), Near Field Communication (NFC), magnetic positioning, and/or cellular triangulation. By way of example, location data is determined via an Internet Protocol (IP) address of a device connected to a wireless network. A wireless router is also operable to determine identities of devices connected to the wireless network through the router, and thus is operable to determine the locations of these devices through their presence in the connection range of the wireless router.

Data Stored on a Distributed Ledger

In a preferred embodiment, the platform is operable to store data on a distributed ledger, e.g., a blockchain. Distributed ledger technology refers to an infrastructure of replicated, shared, and synchronized digital data that is decentralized and distributed across a plurality of machines, or nodes. The nodes include but are not limited to a mobile device, a computer, a server, and/or any combination thereof. Data is replicated and synchronized across a network of nodes such that each node has a complete copy of the distributed ledger. The replication and synchronization of data across a distributed set of devices provides increased transparency over traditional data storage systems, as multiple devices have access to the same set of records and/or database. Additionally, the use of distributed ledgers eliminates the need for third party and/or administrative authorities because each of the nodes in the network is operable to receive, validate, and store additional data, thus creating a truly decentralized system. Eliminating the third party and/or administrative authorities saves time and cost. A decentralized database is also more secure than traditional databases, which are stored on a single device and/or server because the decentralized data is replicated and spread out over both physical and digital space to segregated and independent nodes, making it more difficult to attack and/or irreparably tamper with the data. Tampering with the data at one location does not automatically affect the identical data stored at other nodes, thus providing greater data security.

In addition to the decentralized storage of the distributed ledger, which requires a plurality of nodes, the distributed ledger has further advantages in the way that data is received, validated, communicated, and added to the ledger. When new data is added to the distributed ledger, it must be validated by a portion of the nodes (e.g., 51%) involved in maintaining the ledger in a process called consensus. Proof of work, proof of stake, delegated proof of stake, proof of space, proof of capacity, proof of activity, proof of elapsed time, and/or proof of authority consensus are all compatible with the present invention, as are other forms of consensus known in the art. In one embodiment, the present invention uses fault-tolerant consensus systems. Each node in the system is operable to participate in consensus, e.g., by performing at least one calculation, performing at least one function, allocating compute resources, allocating at least one token, and/or storing data. It is necessary for a portion of the nodes in the system (e.g., 51% of the nodes) to participate in consensus in order for new data to be added to the distributed ledger. Advantageously, requiring that the portion of the nodes participate in consensus while all nodes are operable to participate in consensus means that authority to modify the ledger is not allocated to one node or even a group of nodes but rather is equally distributed across all of the nodes in the system. In one embodiment, a node that participates in consensus is rewarded, e.g., with a digital token, in a process called mining.

The blockchain is a commonly used implementation of a distributed ledger and was described in Satoshi Nakamoto's whitepaper Bitcoin: A Peer-to-Peer Electronic Cash System, which was published in October 2008 and which is incorporated herein by reference in its entirety. In the blockchain, additional data is added to the ledger in the form of a block. Each block is linked to its preceding block with a cryptographic hash, which is a one-way mapping function of the data in the preceding block that cannot practically be computed in reverse. In one embodiment, a timestamp is also included in the hash. The computation of the cryptographic hash based on data in a preceding block is a computationally intensive task that could not practically be conducted as a mental process. The use of cryptographic hashes means that each block is sequentially related to the block before it and the block after it, making the chain as a whole immutable. Data in a block in a preferred embodiment cannot be retroactively altered after it is added to the chain because doing so changes the associated hash, which affects all subsequent blocks in the chain and which breaks the mapping of the preceding block. The blockchain is an improvement on existing methods of data storage because it connects blocks of data in an immutable fashion. Additionally, the blockchain is then replicated and synchronized across all nodes in the system, ensuring a distributed ledger. Any attempted changes to the blockchain are propagated across a decentralized network, which increases the responsiveness of the system to detect and eliminate fraudulent behavior compared to non-distributed data storage systems. The blockchain and the distributed ledger solve problems inherent to computer networking technology by providing a secure and decentralized way of storing data that is immutable and has high fault tolerance. The distributed ledger stores digital data and is thus inextricably tied to computer technology. Additional information about the blockchain is included in The Business of Blockchain by William Mougavar published in April 2016, which is incorporated herein by reference in its entirety.

In one embodiment, the data added to the distributed ledger of the present invention include digital signatures. A digital signature links a piece of data (e.g., a block) to a digital identity (e.g., a user account). In one embodiment, the digital signature is created using a cryptographic hash and at least one private key for a user. The content of the piece of data is used to produce a cryptographic hash. The cryptographic hash and the at least one private key are used to create the digital signature using a signature algorithm. The digital signature is only operable to be created using a private key. However, the digital signature is operable to be decoded and/or verified using a public key also corresponding to the user. The separation of public keys and private keys means that external parties can verify a digital signature of a user using a public key but cannot replicate the digital signature since they do not have a private key. Digital signatures are not merely electronic analogs of traditional physical signatures. Physical signatures are easily accessible and easily replicable by hand. In addition, there is no standard algorithm to verify a physical signature except comparing a first signature with a second signature from the same person via visual inspection, which is not always possible. In one embodiment, the digital signatures are created using the data that is being linked to the digital identity whereas physical signatures are only related to the identity of the signer and are agnostic of what is being signed. Furthermore, digital signatures are transformed into a cryptographic hash using a private key, which is a proof of identity of which there is no physical or pre-electronic analog. Digital signatures, and cryptographic hashes in general, are of sufficient data size and complexity to not be understood by human mental work, let alone verified through the use of keys and corresponding algorithms by human mental work. Therefore, creating, decoding, and/or verifying digital signatures with the human mind is highly impractical.

Public, private, consortium, and hybrid blockchains are compatible with the present invention. In one embodiment, the blockchain system used by the present invention includes sidechains wherein the sidechains run parallel to a primary chain. Implementations of distributed ledger and/or blockchain technology including, but not limited to, BITCOIN, ETHEREUM, HASHGRAPH, BINANCE, FLOW, TRON, TEZOS, COSMOS, and/or RIPPLE are compatible with the present invention. In one embodiment, the platform includes at least one acyclic graph ledger (e.g., at least one tangle and/or at least one hashgraph). In one embodiment, the platform includes at least one quantum computing ledger.

In one embodiment, the present invention further includes the use of at least one smart contract, wherein a smart contract includes a set of automatically executable steps and/or instructions that are dependent on agreed-upon terms. The smart contract includes information including, but not limited to, at least one contracting party, at least one contract address, contract data, and/or at least one contract term. In one embodiment, the at least one smart contract is deployed on a blockchain such that the at least one smart contract is also stored on a distributed node infrastructure. In one embodiment, the terms of the at least one smart contract are dependent on changes to the blockchain. For example, a provision of the at least one smart contract executes when a new block is added to the blockchain that meets the terms of the at least one smart contract. The smart contract is preferably executed automatically when the new block is added to the blockchain. In one embodiment, a first smart contract is operable to invoke a second smart contract when executed. A smart contract is operable to capture and store state information about the current state of the blockchain and/or the distributed ledger at any point in time. Advantageously, a smart contract is more transparent than traditional coded contracts because it is stored on a distributed ledger. Additionally, all executions of the smart contract are immutably stored and accessible on the distributed ledger, which is an improvement over non-distributed, stateless coded contracts. In one embodiment, the state information is also stored on a distributed ledger.

A distributed ledger, such as the blockchain, is used in the present invention to record any information described in the present application, such as transactions between users of the app including ticket purchases, event or activity information such as ratings, comments, and attendance, or any other information operable to be recorded on a distributed ledger such as the blockchain.

Cryptocurrency Transactions

Distributed ledger technology further enables the use of cryptocurrencies. A cryptocurrency is a digital asset wherein ownership records and transaction records of a unit of cryptocurrency (typically a token) are stored in a digital ledger using cryptography. Use of centralized cryptocurrencies and decentralized cryptocurrencies are both compatible with the present invention. Centralized cryptocurrencies are minted prior to issuance and/or are issued by a single body. Records of a decentralized cryptocurrency are stored on a distributed ledger (e.g., a blockchain), and any node participating in the distributed ledger is operable to mint the decentralized cryptocurrency. The distributed ledger thus serves as a public record of financial transactions. Cryptocurrencies are typically fungible in that each token of a given cryptocurrency is interchangeable. The present invention is operable to facilitate transactions of at least one cryptocurrency, including, but not limited to, BITCOIN, LITECOIN, RIPPLE, NXT, DASH, STELLAR, BINANCE COIN, and/or ETHEREUM. In one embodiment, the present invention is operable to facilitate transactions of stablecoins, NEO Enhancement Protocol (NEP) tokens, and/or BINANCE Chain Evolution Proposal (BEP) tokens. In one embodiment, the present invention is operable to support tokens created using the ETHEREUM Request for Comment (ERC) standards as described by the Ethereum Improvement Proposals (EIP). For example, the present invention is operable to support ERC-20-compatible tokens, which are created using the EIP-20: ERC-20 Token Standard, published by Vogelsteller, et al., on Nov. 19, 2015, which is incorporated herein by reference in its entirety.

A cryptocurrency wallet stores keys for cryptocurrency transactions. As cryptocurrency is a virtual currency, the ability to access and transfer cryptocurrency must be protected through physical and/or virtual means such that such actions are only operable to be performed by the rightful owner and/or parties with permission. In one embodiment, a cryptocurrency wallet stores a private key and a public key. In another embodiment, the cryptocurrency wallet is operable to create the private key and/or the public key, encrypt data, and/or sign data (e.g., with a digital signature). In one embodiment, the private key is generated via a first cryptographic algorithm wherein the input to the first cryptographic algorithm is random. Alternatively, the input to the first cryptographic algorithm is non-random. In one embodiment, the public key is generated from the private key using a second cryptographic algorithm. In one embodiment, the first cryptographic algorithm and the second cryptographic algorithm are the same. The private key is only accessible to the owner of the cryptocurrency wallet, while the public key is accessible to the owner of the cryptocurrency wallet as well as a receiving party receiving cryptocurrency from the owner of the cryptocurrency wallet. Deterministic and non-deterministic cryptocurrency wallets are compatible with the present invention.

As a non-limiting example, a cryptocurrency transaction between a first party and a second party involves the first party using a private key to sign a transaction wherein the transaction includes data on a first cryptocurrency wallet belonging to the first party, the amount of the transaction, and a second cryptocurrency wallet belonging to the second party. In one embodiment, the second cryptocurrency wallet is identified by a public key. The transaction is then populated to a distributed network wherein a proportion (e.g., 51%) of the nodes of the distributed network verify the transaction. Verifying the transaction includes verifying that the private key corresponds to the first cryptocurrency wallet and that the amount of the transaction is available in the first cryptocurrency wallet. The nodes then record the transaction on the distributed ledger, e.g., by adding a block to a blockchain. Fulfilling the cryptocurrency transaction is a computationally intensive process due to key cryptography and the consensus necessary for adding data to the distributed ledger that could not practically be performed in the human mind. In one embodiment, a node is operable to verify a block of transactions rather than a single transaction.

Desktop wallets, mobile wallets, hardware wallets, and web wallets are compatible with the present invention. A software wallet (e.g., a desktop wallet, a mobile wallet, a web wallet) stores private and/or public keys in software. A hardware wallet stores and isolates private and/or public keys in a physical unit, e.g., a universal serial bus (USB) flash drive. The hardware wallet is not connected to the internet or any form of wireless communication, thus the data stored on the hardware wallet is not accessible unless the hardware wallet is connected to an external device with network connection, e.g., a computer. In one embodiment, the data on the hardware wallet is not operable to be transferred out of the hardware wallet. In one embodiment, the hardware wallet includes further data security measures, e.g., a password requirement and/or a biometric identifier requirement. In one embodiment, the present invention is operable to integrate a third-party cryptocurrency wallet. Alternatively, the present invention is operable to integrate a payments platform that is compatible with cryptocurrency, including, but not limited to, VENMO, PAYPAL, COINBASE, and/or payments platforms associated with financial institutions.

Ticket purchases or other financial transactions described in the present application are operable to be accomplished using cryptocurrency in one embodiment of the present invention. The mobile application of the present application is operable to connect with a cryptocurrency wallet such as a mobile wallet to perform these transactions. In one embodiment, a mobile wallet of the present invention includes currencies other than cryptocurrency, such as fiat currency deposited from a linked bank account. The wallet is preferably linked to a financial account such as a bank account or credit card account, allowing one user profile to send and/or receive financial compensation from another user profile. The wallet also provides for in-app purchases, such as purchases of amplifications, tickets, or any other goods or services.

Tokenization

In one embodiment, the platform is operable to tokenize assets. A token is a piece of data that is stored on the distributed digital ledger and that can be used to represent a physical and/or a digital asset, e.g., in a transaction, in an inventory. The token is not the asset itself; however, possession and transfer of the token are stored on the distributed digital ledger, thus creating an immutable record of ownership. In one embodiment, the token includes cryptographic hashes of asset data, wherein the asset data is related to the asset. In one embodiment, the asset data is a chain of data blocks. For example, the asset is a work of digital art, and the asset data includes data about the work such as information about an artist, a subject matter, a file type, color data, etc. The corresponding token includes a cryptographic hash of the asset data, which describes the work. Alternative mappings of the asset data to the token are also compatible with the present invention. In one embodiment, the token is a non-fungible token (NFT). A first non-fungible token is not directly interchangeable with a second non-fungible token; rather, the value of the first token and the second token are determined in terms of a fungible unit (e.g., a currency). In one embodiment, the platform is operable to support ETHEREUM standards for tokenization, including, but not limited to, EIP-72 1: ERC-721 Non-Fungible Token Standard by Entriken, et al., which was published Jan. 24, 2018 and which is incorporated herein by reference in its entirety. In one embodiment, the platform is operable to create fractional NFTs (f-NFTs), wherein each f-NFT represents a portion of the asset. Ownership of an f-NFT corresponds to partial ownership of the asset.

Assets such as tickets or virtual memorabilia from events are operable to be tokenized through the mobile application of the present invention according to one embodiment of the present invention. In one embodiment, the tokenized items are operable to be sold to other users through the mobile application.

One of ordinary skill in the art will appreciate that the application of the present invention is operable to be accessed through a variety of interfaces, such as through a wearable electronic device (e.g., APPLE WATCH) or a standalone terminal.

For example, the application of the present invention is operable to be displayed on a terminal in a location such as an airport, a mall, an airplane, a train, an automobile, a hotel, or any other location where different people are operable to interact with the application. In one embodiment, the application includes a user profile specific to the location. For example, a user profile in a hotel is developed based on activities and events taking place in the vicinity of the hotel, and include information about local transportation to these events and activities. The application in the hotel is operable to receive feedback from hotel guests using the application and measure user interest, engagement, trends, and patterns, and update recommendations for future events using an artificial intelligence or machine learning algorithm based on this information.

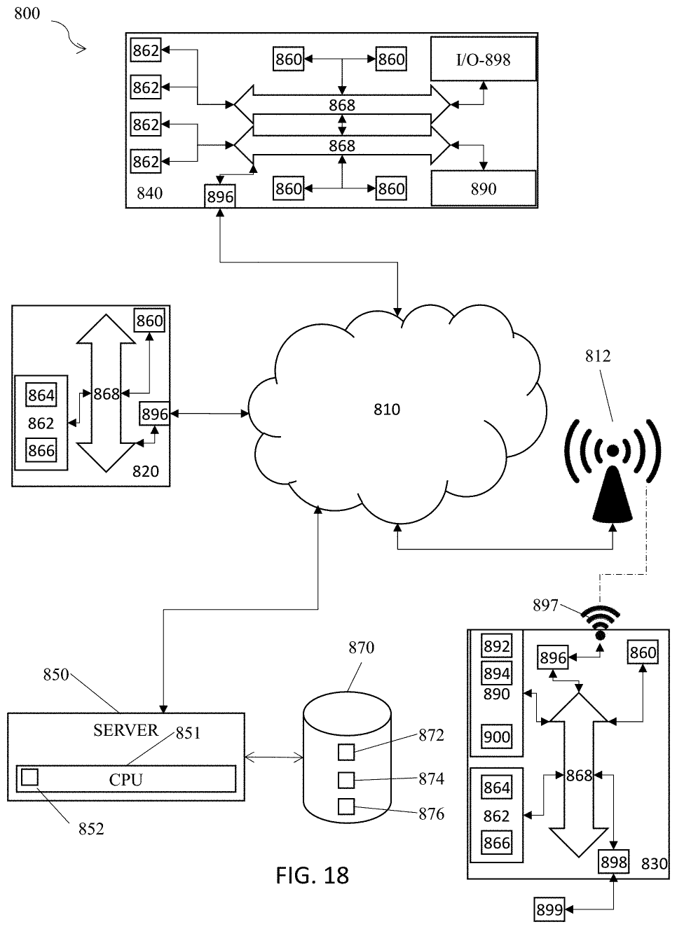

FIG. 18 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, smart watch (e.g., APPLE WATCH, SAMSUNG GEAR, etc.), desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 18, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 18, is operable to include other components that are not explicitly shown in FIG. 18, or is operable to utilize an architecture completely different than that shown in FIG. 18. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A platform for identifying venues of interest, comprising:
a server platform, including a processor and a memory, in network communication with at least one user device;
wherein the server platform generates at least one user profile;
wherein the server platform receives location data corresponding to the at least one user device;
wherein the server platform automatically generates a list of one or more venues within a preset radius of the at least one user device; and
wherein the server platform provides safety protocol measures for each of the one or more venues within the preset radius.

2. The platform of claim 1, wherein the server platform is operable to receive a selection of at least one filter from the at least one user device, and wherein the server platform limits the type of venues on the list of the one or more venues based on the at least one filter.

3. The platform of claim 2, wherein the at least one filter includes a minimum pandemic compliance standard for each venue.

4. The platform of claim 1, wherein the safety protocol measures include pandemic compliance information, including mask requirements, vaccine requirements, average attendee mask compliance, and/or average attendee vaccine compliance.

5. The platform of claim 1, wherein the server platform automatically generates a list of one or more events occurring within a set time period associated with at least one of the one or more venues.

6. The platform of claim 5, wherein the one or more events includes a description, one or more associated videos, one or more category labels, one or more subcategory labels, a minimum price to attend, a start date, and/or an end date for each event.

7. The platform of claim 1, wherein the server platform automatically tracks a number of users entering each of the one or more venues at different times, generates an average number of attendees for the different times, and displays the average number of attendees for a current time period on the list of the one or more venues.

8. The platform of claim 1, wherein the at least one user profile is associated with at least one profile on at least one contact tracing application, and wherein the server platform automatically flags at least one of the one or more venues based on data received from the at least one contact tracing application.

9. The platform of claim 1, wherein the server platform is integrated with at least one ticketing application, and wherein the server platform is operable to receive a selection to purchase at least one ticket for at least one event associated with the one or more venues from the at least one user device.

10. A platform for identifying venues of interest, comprising:
a server platform, including a processor and a memory, in network communication with at least one user device;
wherein the server platform generates at least one user profile;
wherein the server platform receives location data corresponding to the at least one user device;
wherein the server platform automatically generates a list of one or more venues within a preset radius of the at least one user device; and
wherein the list of one or more venues is generated by a machine learning module based on entertainment preference data for the at least one user profile, event preference data for the at least one user profile, historical attendance data for the at least one user profile, historical reaction data for the at least one user profile, and/or an age associated with the at least one user profile.

11. The platform of claim 10, wherein the historical reaction data includes one or more previous events or venues liked by the at least one user profile, one or more previous events or venues loved by the at least one user profile, one or more previous events or venues lost by the at least one user profile, and/or one or more previous events or venues disliked by the at least one user profile.

12. The platform of claim 10, wherein the list of one or more venues is further generated based on safety protocol measure preferences for the at least one user profile.

13. The platform of claim 10, wherein the server platform automatically tracks a number of users entering each of the one or more venues at different times, generates an average number of attendees for the different times, and displays the average number of attendees for a current time period on the list of the one or more venues.

14. The platform of claim 10, wherein the at least one user profile is associated with at least one profile on at least one contact tracing application, and wherein the server platform automatically flags at least one of the one or more venues based on data received from the at least one contact tracing application.

15. The platform of claim 10, wherein the server platform is integrated with at least one ticketing application, and wherein the server platform is operable to receive a selection to purchase at least one ticket for at least one event associated with the one or more venues from the at least one user device.

16. The platform of claim 10, wherein the server platform provides safety protocol measures for each of the one or more venues within the preset radius.

17. A platform for identifying venues of interest, comprising:
a server platform, including a processor and a memory, in network communication with at least one user device;
wherein the server platform generates at least one user profile;
wherein the server platform receives location data corresponding to the at least one user device;
wherein the server platform automatically generates a list of one or more venues within a preset radius of the at least one user device; and
wherein the at least one user profile is associated with at least one profile on at least one contact tracing application, and wherein the server platform automatically generates an alert concerning at least one of the one or more venues based on data received from the at least one contact tracing application.

18. The platform of claim 17, wherein the server platform automatically tracks a number of users entering each of the one or more venues at different times, generates an average number of attendees for the different times, and displays the average number of attendees for a current time period on the list of the one or more venues.

19. The platform of claim 17, wherein the server platform is integrated with at least one ticketing application, and wherein the server platform is operable to receive a selection to purchase at least one ticket for at least one event associated with the one or more venues from the at least one user device.

20. The platform of claim 17, wherein the server platform provides safety protocol measures for each of the one or more venues within the preset radius.
